(19) United States
(12) Patent Application Publication
(10) Pub. No.: US 2004/0209115 A1
(43) Pub. Date: Oct. 21, 2004

(54) Organic light emitting devices with wide gap host materials

(76) Inventors: Mark E. Thompson, Anaheim, CA (US); Peter Djurovich, Los Angeles, CA (US); Xiaofan Ren, Los Angeles, CA (US); Russell J. Holmes, Princeton, NJ (US); Stephen R. Forrest, Princeton, NJ (US)

Correspondence Address: KENYON & KENYON, ONE BROADWAY, NEW YORK, NY, 10004, US

(21) Appl. No.: 10/420,430

(22) Filed: Apr. 21, 2003

(51) Int. Cl. H05B 33/14

(52) U.S. Cl. 428/690; 257/40; 313/504; 428/917

(57) ABSTRACT

The present invention relates to organic light emitting devices (OLEDs), and more specifically to efficient OLEDs having an emissive layer having host material with a wide energy gap. The present invention also relates to materials for use as a wide gap host material.

### FIELD OF THE INVENTION

The present invention relates to organic light emitting devices (OLEDs), and more specifically to efficient OLEDs having an emissive layer having host material with a wide energy gap. The present invention also relates to materials for use as a wide gap host material. The devices and materials of the present invention may be useful in the fabrication of OLED which are capable of emission in the blue region of the visible spectrum.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices, organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

OLED devices are generally (but not always) intended to emit light through at least one of the electrodes, and one or more transparent electrodes may be useful in an organic opto-electronic device. For example, a transparent electrode material, such as indium tin oxide (ITO), may be used as the bottom electrode. A transparent top electrode, such used in a top-emitting device, as disclosed in U.S. Pat. Nos. 5,703,436, 5,707,745 and 6,548,956, which are incorporated by reference in their entireties, may also be used. For a device intended to emit light only through the bottom electrode, the top electrode does not need to be transparent, and may be comprised of a thick and reflective metal layer having a high electrical conductivity. Similarly, for a device intended to emit light only through the top electrode, the bottom electrode may be opaque and/or reflective. Where an electrode does not need to be transparent, using a thicker layer may provide better conductivity, and using a reflective electrode may increase the amount of light emitted through the other electrode, by reflecting light back towards the transparent electrode. Fully transparent devices may also be fabricated, where both electrodes are transparent. Side emitting OLEDs may also be fabricated, and one or both electrodes may be opaque or reflective in such devices.

As used herein, “top” means furthest away from the substrate, while “bottom” means closest to the substrate. For example, for a device having two electrodes, the bottom electrode is the electrode closest to the substrate, and is generally the first electrode fabricated. The bottom electrode has two surfaces, a bottom surface closest to the substrate, and a top surface further away from the substrate. Where a first layer is described as “disposed over” a second layer, the first layer is disposed further away from substrate. There may be other layers between the first and second layer, unless it is specified that the first layer is “in physical contact with” the second layer. For example, a cathode may be described as “disposed over” an anode, even though there are various organic layers in between.

In the emissive layer of conventional devices, the host is generally selected to be a primary charge carrier and the site for initial exciton formation. Host materials commonly used for the emissive region tend to have triplet energies corresponding to emission in the green portion of the visible spectrum. When a phosphorescent dopant that emits in the blue is doped into such an emissive region, emission will come largely from the host, if at all, rather than the blue phosphorescent dopant. To date, relatively low quantum efficiencies have been generally observed from blue phosphorescent devices due to exothermic or endothermic energy quenching to the host, and quenching by the host charge carriers. According, there is a great interest in finding efficient OLEDs that are able to emit in the blue region of the visible spectrum.

### SUMMARY OF THE INVENTION

An organic light emitting device is provided. The devices of the present invention comprise an emissive layer disposed between and electrically connected to an anode and a cathode, wherein the emissive layer comprises a host material and a phosphorescent emissive material. The host material is a “wide gap” material, preferably having an energy gap of at least 3.2 eV. In one embodiment of the invention, the emissive material is the primary carrier of holes and electrons in the emissive layer. In this case, the host material is a non-charge-carrying. The invention further provides an organic light emitting device in which emissive material is the primary carrier of holes and the host material is the primary carrier of electrons. In an alternative embodiment, the emissive material is the primary carrier of electrons and the host material is the primary carrier of holes.

The present invention provides efficient devices, wherein the external quantum efficiency is at least about 3%, and preferably at least about 5%. Further, the devices of the present invention may be used with phosphorescent emissive materials that emit light in the blue region of the visible spectrum.

The present invention also provides materials for use as wide-gap hosts in the emissive layers of organic light emitting devices.

### BRIEF DESCRIPTION OF THE DRAWINGS

FIG. 1 shows an organic light emitting device having separate electron transport, hole transport, and emissive layers, as well as other layers.

FIG. 2 shows an inverted organic light emitting device that does not have a separate electron transport layer.

FIG. 3 shows the electrochemical properties of 5,5′-Spirobi(dibenzosilole). The electrochemical data suggests that this material has a wide energy gap.

FIG. 4 shows the absorption and emission spectra for 5,5′-spirobi(dibenzosilole).

FIG. 5 shows the plot of the current density vs. voltage for the device ITO/NPD(400 Å)/Irppy:host(8%, 300 Å)/BCP(150 Å)/Alq(250 Å)/LiF/Al, in which the host is CBP or 5,5′-spirobi(dibenzosilole) (Si(bph)₂).

FIG. 6 shows the plot of the brightness vs. voltage for the device ITO/NPD(400 Å)/Irppy:host(8%, 300 Å)/BCP(150 Å)/Alq(250 Å)/LiF/Al, in which the host is CBP or 5,5′-spirobi(dibenzosilole).

FIG. 7 shows the plot of the quantum efficiency vs. current density for the device ITO/NPD(400 Å)/Irppy:host(8%, 300 Å)/BCP(150 Å)/Alq(250 Å)/LiF/Al, in which the host is CBP or 5,5′-spirobi(dibenzosilole).

FIG. 8 shows the absorption and emission spectra for diphenyldi(o-tolyl)silane.

FIG. 9 shows the plot of the current density vs. voltage for the device ITO/NPD(400 Å)/Irppy:host(8%, 300 Å)/BCP(150 Å)/Alq(250 Å)/LiF/Al, in which the host is CBP or diphenyldi(o-tolyl)silane (Siph₂(o-tolyl)₂).

FIG. 10 shows the plot of the brightness vs. voltage for the device ITO/NPD(400 Å)/Irppy:host(8%, 300 Å)/BCP(150 Å)/Alq(250 Å)/LiF/Al, in which the host is CBP or diphenyldi(o-tolyl)silane (Siph₂(o-tolyl)₂).

FIG. 11 shows the plot of the quantum efficiency vs. current density for the device ITO/NPD(400 Å)/Irppy:host(8%, 300 Å)/BCP(150 Å)/Alq(250 Å)/LiF/Al, in which the host is CBP or diphenyldi(o-tolyl)silane (Siph₂(o-tolyl)₂).

FIG. 12 shows a comparison of the energy level diagrams for a standard blue device having the emissive dopant Ir(4,6-F₂ ppy)₂(BPz₄) in an mCP host and a device having a wide band gap host, diphenyldi(o-tolyl)silane. The wide bad gap device employs a layer of mCP as a “step” layer.

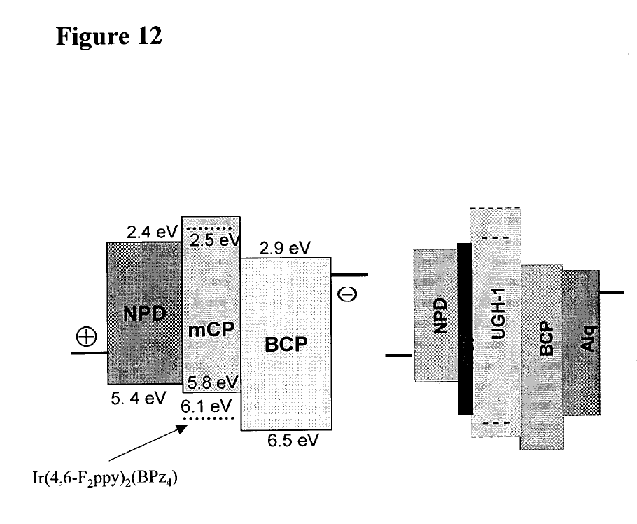

FIG. 13 shows the plot of the current density vs. voltage for the device ITO/NPD(400 Å)/mCP(100 Å)/Ir(4,6-F₂ ppy)₂(BPz₄):host(8-9%, 250 Å)/BCP(150 Å)/Alq(250 Å)/LiF/Al, in which the host is mCP or diphenyldi(o-tolyl)silane (Siph₂(o-tolyl)₂).

FIG. 14 shows the plot of the brightness vs. voltage for the device ITO/NPD(400 Å)/mCP(100 Å)/Ir(4,6-F₂ ppy)₂(BPz₄):host(8-9%, 250 Å)/BCP(150 Å)/Alq(250 Å)/LiF/Al, in which the host is mCP or diphenyldi(o-tolyl)silane (Siph₂(o-tolyl)₂).

FIG. 15 shows the plot of the quantum efficiency vs. current density for the device ITO/NPD(400 Å)/mCP(100 Å)/Ir(4,6-F₂ ppy)₂(BPz₄):host(8-9%, 250 Å)/BCP(150 Å)/Alq(250 Å)/LiF/Al, in which the host is mCP or diphenyldi(o-tolyl)silane (Siph₂(o-tolyl)₂).

FIG. 16 shows the plot of the current density vs. voltage for the device ITO/NPD(400 Å)/mCP(100 Å)/Ir(4,6-F₂ ppy)₂(BPz₄):UGH1(250 Å)/BCP(150 Å)/Alq(250 Å)/LiF/Al at various dopant concentrations.

FIG. 17 shows the plot of the brightness vs. voltage for the device ITO/NPD(400 Å)/mCP(100 Å)/Ir(4,6-F₂ ppy)₂(BPz₄):UGH1(250 Å)/BCP(150 Å)/Alq(250 Å)/LiF/Al at various dopant concentrations.

FIG. 18 shows the plot of the quantum efficiency vs. current density for the device ITO/NPD(400 Å)/mCP(100 Å)/Ir(4,6-F₂ ppy)₂(BPZ₄):UGH1(250 Å)/BCP(150 Å)/Alq(250 Å)/LiF/Al at various dopant concentrations.

FIG. 19 shows the photoluminescent spectra for the device ITO/NPD(400 Å)/mCP(100 Å)/Ir(4,6-F₂ ppy)₂(BPz₄):UGH1 (250 Å)/BCP(150 Å)/Alq(250 Å)/LiF/Al at various dopant concentrations.

FIG. 20 shows the plots of the current density vs. voltage for the devices ITO/NPD(400 Å)/Firpic:UGH1(300 Å)/BCP(150 Å)/Alq(250 Å)/LiF/Al, ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

FIG. 21 shows the plots of the brightness vs. voltage for the devices ITO/NPD(400 Å)/Firpic:UGH1 (300 Å)/BCP(150 Å)/Alq(250 Å)/LiF/Al, ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

FIG. 22 shows the plots of the quantum efficiency vs. current density for the devices ITO/NPD(400 Å)/Firpic:UGH1(300 Å)/BCP(150 Å)/Alq(250 Å)/LiF/Al, ITO/NPD(400 Å)/mCP/Firpic:UGH1 (300 Å)/Alq(250 Å)/LiF/Al, and ITO/NPD(400 Å)/Firpic:mCP(300 Å)/Alq(250 Å)/LiF/Al.

FIG. 23 shows the plots of the photoluminescent spectra for the devices ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

FIG. 24 shows the absorption and emission spectra for 9,9spirobissilaanthracene.

FIG. 25 shows the absorption and emission spectra for octaphenyl-polyhedral oligomeric silsesquioxane.

FIG. 26 shows the plots of the quantum efficiency vs. current density and the power efficiency vs. current density for a device of the structure ITO/NPD(400 Å)/mCP(100 Å)/Ir(4,6-F₂ ppy)₂(BPz₄):Siph₂(o-tolyl)₂(10%, 250 Å)/BCP(400 Å)/LiF/Al.

FIG. 27 shows the plots of current density vs. voltage and luminescence vs. voltage for the device of the structure ITO/NPD(400 Å)/mCP(100 Å)/Ir(4,6-F₂ ppy)₂(BPz₄): Siph₂(o-tolyl)₂(10%, 250 Å)/BCP(400 Å)/LiF/Al.

FIG. 28 shows the electroluminescence spectra for the device of the structure ITO/NPD(400 Å)/mCP(100 Å)/Ir(4,6-F₂ ppy)₂(BPz₄) Siph₂(O-tolyl)₂(10%, 250 Å)/BCP(400 Å)/LiF/Al when driven at three different current densities, 1 mA/cm², 10 mA/cm², and 100 mA/cm².

FIG. 29 shows the chemical structures for Irppy, Ir(4,6-F₂ ppy)₂(BPz₄), 5,5′-Spirobi(dibenzosilole) (Si(bph)₂; UGH1), diphenyldi(o-tolyl)silane (Siph₂(o-tolyl)₂; UGH2), for 9,9-spirobissilaanthracene, and octaphenyl-polyhedral oligomeric silsesquioxane.

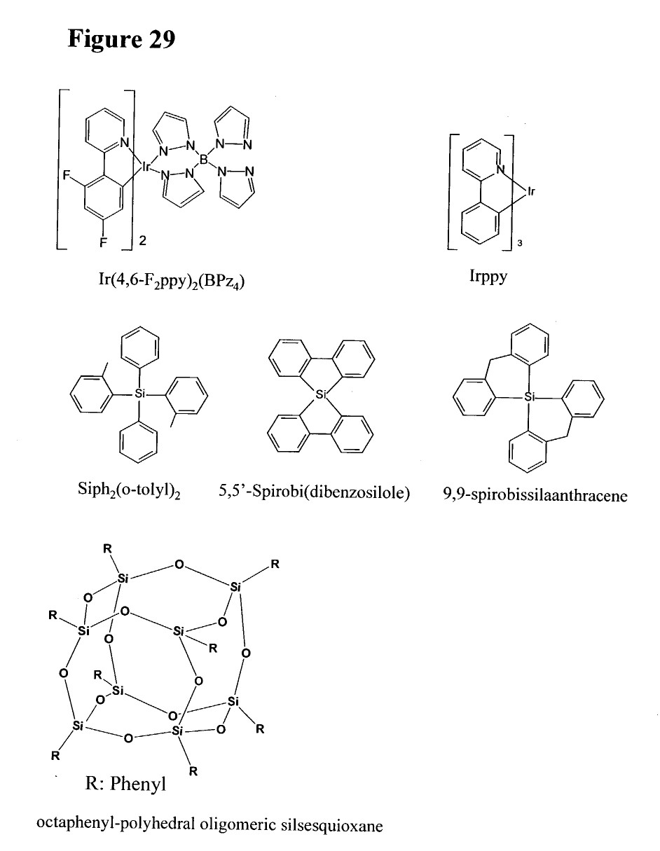

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence may be referred to as a “forbidden” transition because the transition requires a change in spin states, and quantum mechanics indicates that such a transition is not favored. As a result, phosphorescence generally occurs in a time frame exceeding at least 10 nanoseconds, and typically greater than 100 nanoseconds. If the natural radiative lifetime of phosphorescence is too long, triplets may decay by a non-radiative mechanism, such that no light is emitted. Organic phosphorescence is also often observed in molecules containing heteroatoms with unshared pairs of electrons at very low temperatures. 2,2′-bipyridine is such a molecule. Non-radiative decay mechanisms are typically temperature dependent, such that a material that exhibits phosphorescence at liquid nitrogen temperatures may not exhibit phosphorescence at room temperature. But, as demonstrated by Baldo, this problem may be addressed by selecting phosphorescent compounds that do phosphoresce at room temperature.

Generally, the excitons in an OLED are believed to be created in a ratio of about 3:1, i.e., approximately 75% triplets and 25% singlets. See, Adachi et al., “Nearly 100% Internal Phosphorescent Efficiency In An Organic Light Emitting Device,” J. Appl. Phys., 90, 5048 (2001), which is incorporated by reference in its entirety. In many cases, singlet excitons may readily transfer their energy to triplet excited states via “intersystem crossing,” whereas triplet excitons may not readily transfer their energy to singlet excited states. As a result, 100% internal quantum efficiency is theoretically possible with phosphorescent OLEDs. In a fluorescent device, the energy of triplet excitons is generally lost to radiationless decay processes that heat-up the device, resulting in much lower internal quantum efficiencies. OLEDs utilizing phosphorescent materials that emit from triplet excited states are disclosed, for example, in U.S. Pat. No. 6,303,238, which is incorporated by reference in its entirety.

Phosphorescence may be preceded by a transition from a triplet excited state to an intermediate non-triplet state from which the emissive decay occurs. For example, organic molecules coordinated to lanthamide elements often phosphoresce from excited states localized on the lanthamide metal. However, such materials do not phosphoresce directly from a triplet excited state but instead emit from an atomic excited state centered on the lanthamide metal ion. The europium diketonate complexes illustrate one group of these types of species.

Phosphorescence from triplets can be enhanced over fluorescence by confining, preferably through bonding, the organic molecule in close proximity to an atom of high atomic number. This phenomenon, called the heavy atom effect, is created by a mechanism known as spin-orbit coupling. Such a phosphorescent transition may be observed from an excited metal-to-ligand charge transfer (MLCT) state of an organometallic molecule such as tris(2-phenylpyridine)iridium(III).

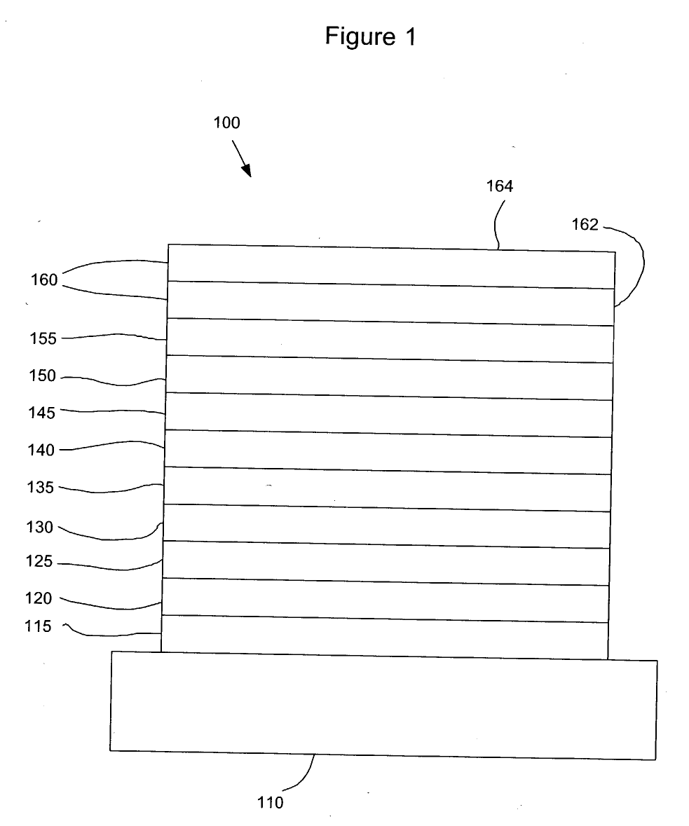

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order.

Substrate 110 may be any suitable substrate that provides desired structural properties. Substrate 110 may be flexible or rigid. Substrate 110 may be transparent, translucent or opaque. Plastic and glass are examples of preferred rigid substrate materials. Plastic and metal foils are examples of preferred flexible substrate materials. Substrate 110 may be a semiconductor material in order to facilitate the fabrication of circuitry. For example, substrate 110 may be a silicon wafer upon which circuits are fabricated, capable of controlling OLEDs subsequently deposited on the substrate. Other substrates may be used. The material and thickness of substrate 110 may be chosen to obtain desired structural and optical properties.

Anode 115 may be any suitable anode that is sufficiently conductive to transport holes to the organic layers. The material of anode 115 preferably has a work function higher than about 4 eV (a “high work function material”). Preferred anode materials include conductive metal oxides, such as indium tin oxide (ITO) and indium zinc oxide (IZO), aluminum zinc oxide (AlZnO), and metals. Anode 115 (and substrate 110) may be sufficiently transparent to create a bottom-emitting device. A preferred transparent substrate and anode combination is commercially available ITO (anode) deposited on glass or plastic (substrate). A flexible and transparent substrate-anode combination is disclosed in U.S. Pat. No. 5,844,363, which is incorporated by reference in its entirety. Anode 115 may be opaque and/or reflective. A reflective anode 115 may be preferred for some top-emitting devices, to increase the amount of light emitted from the top of the device. The material and thickness of anode 115 may be chosen to obtain desired conductive and optical properties. Where anode 115 is transparent, there may be a range of thickness for a particular material that is thick enough to provide the desired conductivity, yet thin enough to provide the desired degree of transparency. Other anode materials and structures may be used.

Hole transport layer 125 may include a material capable of transporting holes. Hole transport layer 130 may be intrinsic (undoped), or doped. Doping may be used to enhance conductivity. 4,4′-Bis[N-(1-naphthyl)-N-phenyl-amino]biphenyl (oc-NPD) and as N,N′-diphenyl-N,N′-bis(3-methylphenyl) 1-1′biphenyl-4,4′diamine (TPD) are examples of intrinsic hole transport layers. An example of a p-doped hole transport layer is m-MTDATA doped with F₄-TCNQ at a molar ratio of 50: 1, as disclosed in U.S. patent application Ser. No. 10/173,682 to Forrest et al., which is incorporated by reference in its entirety. Other hole transport layers may be used.

Emissive layer 135 includes an organic material capable of emitting light when a current is passed between anode 115 and cathode 160. Preferably, emissive layer 135 contains a phosphorescent emissive material, although fluorescent emissive materials may also be used. Phosphorescent materials are preferred because of the higher luminescent efficiencies associated with such materials. Emissive layer 135 comprises a wide gap host material, doped with an emissive material. Emissive layer 135 may comprise other materials, such as dopants that tune the emission of the emissive material. Emissive layer 135 may include a plurality of emissive materials capable of, in combination, emitting a desired spectrum of light. Examples of phosphorescent emissive materials include Ir(ppy)₃. Examples of fluorescent emissive materials include DCM and DMQA. Examples of phosphorescent emissive materials are disclosed in U.S. Pat. No. 6,303,238 to Thompson et al., which is incorporated by reference in its entirety. Emissive material may be included in emissive layer 135 in a number of ways. For example, an emissive small molecule may be incorporated into a polymer. Other emissive layer materials and structures may be used.

Electron transport layer 140 may include a material capable of transporting electrons. Electron transport layer 140 may be intrinsic (undoped), or doped. Doping may be used to enhance conductivity. Alq₃ is an example of an intrinsic electron transport layer. An example of an n-doped electron transport layer is BPhen doped with Li at a molar ratio of 1:1, as disclosed in U.S. patent application Ser. No. 10/173,682 to Forrest et al., which is incorporated by reference in its entirety. Other electron transport layers may be used.

The charge carrying component of the electron transport layer may be selected such that electrons can be efficiently injected from the cathode into the LUMO (Lowest Unoccupied Molecular Orbital) level of the electron transport layer. In this case, the “charge carrying component” is the material responsible for the LUMO that actually transports electrons. This component may be the base material, or it may be a dopant. The LUMO level of an organic material may be generally characterized by the electron affinity of that material and the relative electron injection efficiently of a cathode may be generally characterized in terms of the work function of the cathode material. This means that the preferred properties of an electron transport layer and the adjacent cathode may be specified in terms of the electron affinity of the charge carrying component of the ETL and the work function of the cathode material. In particular, so as to achieve high electron injection efficiency, the work function of the cathode material is preferably not greater than the electron affinity of the charge carrying component of the electron transport layer by more than about 0.75 eV, more preferably, by not more than about 0.5 eV. Similar considerations apply to any layer into which electrons are being injected.

Cathode 160 may be any suitable material or combination of materials known to the art, such that cathode 160 is capable of conducting electrons and injecting them into the organic layers of device 100. Cathode 160 may be transparent or opaque, and may be reflective. Metals and doped metal oxides are examples of suitable cathode materials. Cathode 160 may be a single layer, or may have a compound structure. FIG. 1 shows a compound cathode 160 having a thin metal layer 162 and a thicker conductive metal oxide layer 164. In a compound cathode, preferred materials for the thicker layer 164 include ITO, IZO, and other materials known to the art. U.S. Pat. Nos. 5,703,436, 5,707,745 and 6,548,956 disclose examples of cathodes including compound cathodes having a thin layer of metal such as Mg:Ag with an overlying transparent, electrically-conductive, sputter-deposited ITO layer. The part of cathode 160 that is in contact with the underlying organic layer, whether it is a single layer cathode 160, the thin metal layer 162 of a compound cathode, or some other part, is preferably made of a material having a work function lower than about 4 eV (a “low work function material”). Other cathode materials and structures may be used.

Blocking layers may be used to reduce the number of charge carriers (electrons or holes) and/or excitons that leave the emissive layer. An electron blocking layer 130 may be disposed between emissive layer 135 and the hole transport layer 125, to inhibit electrons from leaving emissive layer 135 in the direction of hole transport layer 125. Similarly, a hole blocking layer 140 may be disposed between emissive layer 135 and electron transport layer 145, to inhibit holes from leaving emissive layer 135 in the direction of electron transport layer 140. Blocking layers may also be used to inhibit excitons from diffusing out of the emissive layer. The theory and use of blocking layers is described in more detail in U.S. Pat. No. 6,097,147 and U.S. patent application Ser. No. 10/173,682 to Forrest et al., which are incorporated by reference in their entireties. Blocking layers can serve one or more blocking functions. For example, a hole blocking layer can also serve as an exciton blocking layer. In some embodiments, the hole blocking layer does not simultaneously serve as an emissive layer in devices of the present invention. Although a blocking layer can include compounds that are capable of emitting, emission can occur in a separate emissive layer. Thus, in preferred embodiments, the blocking layer does not luminesce. Blocking layers can be thinner than carrier layers. Typical blocking layers have a thickness ranging from about 50 Å.

An electron blocking layers functions to confine electrons to specific regions of the light emitting devices. For example, device efficiency can be increased if electrons are inhibited from migrating out of the emissive layer (EL). Electron blocking layers are comprised of materials that have difficulty acquiring electrons (i.e., are relatively difficult to reduce). In the context of a light emitting device, electron blocking layers are preferably more difficult to reduce than the adjacent layer from which electrons migrate. A material that is more difficult to reduce than another material generally has a higher LUMO energy level. As an example, electrons originating from the cathode and migrating into an EL layer can be blocked from exiting the EL (on the anode side) by placing a blocking layer adjacent to the anode side of the EL where the blocking layer has a LUMO energy level higher than the LUMO energy level of the EL. Larger differences in LUMO energy levels correspond to better electron blocking ability. The LUMO of the materials of the blocking layer are preferably at least about 300 meV, or more, above the LUMO level of an adjacent layer in which holes are to be confined. In some embodiments, the LUMO of the materials of the blocking layer can be at least about 200 meV above the LUMO level of an adjacent layer in which holes are to be confined.

Electron blocking layers are also preferably good hole injectors. Accordingly, the HOMO energy level of the EBL is preferably close to the HOMO energy level of the layer in which electrons are to be confined. It is preferable that differences in HOMO energy levels between the two layers is less than the differences in LUMO energies, leading to a lower barrier for migration of holes across the interface than for the migration of electrons form the emissive layer into the electron blocking layer. Electron blocking layers that are also good hole injectors typically have smaller energy barriers to hole injection than for electron leakage. Accordingly, the difference between the HOMO energies of the EBL and the layer in which electrons are to be confined (corresponding to an hole injection energy barrier) is smaller than the difference in their LUMO energies (i.e., electron blocking energy barrier).

As would be generally understood by one skilled in the art, use of the term “blocking” layer is meant to suggest that the layer is comprised of a material, or materials, that provide a barrier that significantly inhibits transport of charge carriers and/or excitons through the layer, without suggesting or implying that the barrier completely blocks all charge carriers and/or excitons. The presence of such a barrier typically manifests itself in terms of producing substantially higher efficiencies as compared to devices lacking the blocking layer, and/or in terms of confining the emission to the desired region of the OLED.

Generally, injection layers are comprised of a material that may improve the injection of charge carriers from one layer, such as an electrode or an organic layer, into an adjacent organic layer. Injection layers may also perform a charge transport function. In device 100, hole injection layer 120 may be any layer that improves the injection of holes from anode 115 into hole transport layer 125. CuPc is an example of a material that may be used as a hole injection layer from an ITO anode 115, and other anodes. In device 100, electron injection layer 150 may be any layer that improves the injection of electrons into electron transport layer 145. LiF/Al is an example of a material that may be used as an electron injection layer into an electron transport layer from an adjacent layer. Other materials or combinations of materials may be used for injection layers. Depending upon the configuration of a particular device, injection layers may be disposed at locations different than those shown in device 100. More examples of injection layers are provided in U.S. patent application Ser. No. 09/931,948 to Lu et al., which is incorporated by reference in its entirety. A hole injection layer may comprise a solution deposited material, such as a spin-coated polymer, e.g., PEDOT:PSS, or it may be a vapor deposited small molecule material, e.g., CuPc or MTDATA.

A hole injection layer (HIL) may planarize or wet the anode surface so as to provide efficient hole injection from the anode into the hole injecting material. A hole injection layer may also have a charge carrying component having HOMO (Highest Occupied Molecular Orbital) energy levels that favorably match up, as defined by their herein-described relative ionization potential (IP) energies, with the adjacent anode layer on one side of the HIL and the hole transporting layer on the opposite side of the HIL. In this case, the “charge carrying component” is the material responsible for the HOMO that actually transports holes. This component may be the base material of the HIL, or it may be a dopant. Using a doped HIL allows the dopant to be selected for its electrical properties, and the host to be selected for morphological properties such as wetting, flexibility, toughness, etc. Preferred properties for the HIL material are such that holes can be efficiently injected from the anode into the HIL material. In particular, the charge carrying component of the HIL preferably has an IP not more than about 0.7 eV greater that the IP of the anode material. More preferably, the charge carrying component has an IP not more than about 0.5 eV greater than the anode material. Similar considerations apply to any layer into which holes are being injected. HIL materials are further distinguished from conventional hole transporting materials that are typically used in the hole transporting layer of an OLED in that such HIL materials may have a hole conductivity that is substantially less than the hole conductivity of conventional hole transporting materials. The thickness of the HIL of the present invention may be thick enough to help planarize or wet the surface of the anode layer. For example, an HIL thickness of as little as 10 nm may be acceptable for a very smooth anode surface. However, since anode surfaces tend to be very rough, a thickness for the HIL of up to 50 nm may be desired in some cases.

A protective layer may be used to protect underlying layers during subsequent fabrication processes. For example, the processes used to fabricate metal or metal oxide top electrodes may damage organic layers, and a protective layer may be used to reduce or eliminate such damage. In device 100, protective layer 155 may reduce damage to underlying organic layers during the fabrication of cathode 160. Preferably, a protective layer has a high carrier mobility for the type of carrier that it transports (electrons in device 100), such that it does not significantly increase the operating voltage of device 100. CuPc, BCP, and various metal phthalocyanines are examples of materials that may be used in protective layers. Other materials or combinations of materials may be used. The thickness of protective layer 155 is preferably thick enough that there is little or no damage to underlying layers due to fabrication processes that occur after organic protective layer 160 is deposited, yet not so thick as to significantly increase the operating voltage of device 100. Protective layer 155 may be doped to increase its conductivity. For example, a CuPc or BCP protective layer 160 may be doped with Li. A more detailed description of protective layers may be found in U.S. patent application Ser. No. 09/931,948 to Lu et al., which is incorporated by reference in its entirety.

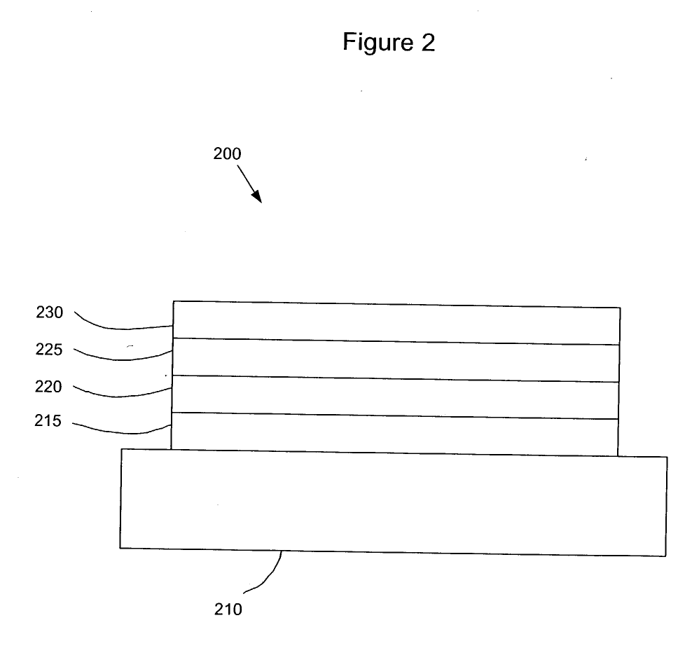

FIG. 2 shows an inverted OLED 200. The device includes a substrate 210, an cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190, Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJP. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

As used herein, “solution processible” means capable of being dissolved, dispersed, or transported in and/or deposited from a liquid medium, either in solution or suspension form.

The devices of the present invention comprise an emissive layer, wherein the emissive layer comprises a host material that has a wide energy gap. As used herein, the energy gap refers to the difference in the energy between the highest occupied molecular orbital (HOMO) and the lowest unoccupied molecular orbital (LUMO) for a particular compound. The triplet energy for a given material is related to, but less than, the energy gap. Materials for use as a wide gap host are selected to have an wide energy gap so that the host material does not quench the dopant emission by endothermic or exothermic energy transfer. The wide gap host is selected so as to have a triplet energy at least about 300 mV higher than that of the dopant.

When the emissive dopant is selected from a phosphorescent blue-emitting dopant, the wide gap host may have an energy gap that is greater than 3.0 eV. Preferably, the energy gap is about 3.2 eV or greater. In preferred embodiments of the invention, the emissive material is selected to emit radiation with an emission peak in the high energy, blue region of the visible spectrum. This corresponds to an emission in the range from about 430 nm to about 470 nm. For emissive compounds that emit in the high energy portion of the visible spectrum (e.g., blue), an energy gap of about 3.5 eV or greater may be particularly preferred.

In one embodiment of the invention, the LUMO of the host will be higher than the LUMO for the emissive dopant and the HOMO for the host will be lower than the HOMO for the emissive dopant. Thus, the HOMO and LUMO of the emissive dopant are “nested” within the HOMO and LUMO for the host. In this case, the dopant will act as the primary charge carrier for both electrons and holes in the emissive layer, as well as the site for the trapping of excitons. The wide gap host material will function as a non-charge-carrying material in this system. The so-called non-charge-carrying material may be able to carry charge to some small degree. Preferably, the non-charge-carrying material may be characterized herein as one that carries at least about ten-times less current than the charge carrying material. In another embodiment of the invention, a second dopant may be added to the emissive layer to function as the primary charge carrier for either electrons or holes.

In another embodiment of the invention, the LUMO of the host will be higher than the LUMO for the emissive dopant and the HOMO for the host will be higher than the HOMO for the emissive dopant. In this case, the host material will act as the primary carrier of holes in the emissive layer and the emissive dopant will act as the primary carrier of electrons. In an alternate embodiment, the LUMO of the host will be lower than the LUMO for the emissive dopant and the HOMO for the host will be lower than the HOMO for the emissive dopant. In this case, the host material will act as the primary carrier of electrons in the emissive layer and the emissive dopant will act as the primary carrier of holes. In the cases in which the HOMO and LUMO of the emissive dopant are not nested within the HOMO and LUMO for the host, there could exist the potential for the formation of an exciplex. An exciplex is an excited state whose wave function straddles two dissimilar molecules, wherein one molecule is a net electron donor and the other is an acceptor. The energy of the exciplex is generally proportional to the energy difference between the orbitals from which the exciplex was composed. To avoid exciplex formation, the estimated exciplex energy should be higher than the triplet energy of the emissive dopant. Preferably, the estimated exciplex energy exceeds the triplet energy of the emissive dopant by about 200-300 mV, or more. The energy to the exciplex may be estimated by the HOMO-LUMO energy difference between the host and the dopant.

When a charge carrying dopant is employed in addition to an emissive dopant in the emissive layer, the same considerations concerning the formation of a low energy exciplex should be considered. Thus, the charge carrying dopant should have a higher triplet energy than that of the emitting dopant and the estimated exciplex energy exceeds the triplet energy of the emissive dopant by about 200-300 mV, or more.

The HOMO and LUMO energy levels for organic materials to be used in OLEDs have been estimated in several ways. The two common methods for estimating HOMO levels are solution electrochemistry and ultraviolet photoelectron spectroscopy (UPS). The two common methods for estimating LUMO levels are solution electrochemistry and inverse photoemission spectroscopy. These energies are useful for predicting the interactions described herein between the emissive material and the host material of the emissive layer. Additionally, the alignment of the HOMO and LUMO levels between adjacent layers will control the passage of hole and electrons between the two layers.

The most common method for determining oxidation and reduction potentials is cyclic voltametry. A simple description of this process is as follows. The unknown is dissolved along with a high concentration of electrolyte. Electrodes are inserted and the voltage scanned in either the positive or negative direction (depending on whether an oxidation or reduction is being performed). The presence of a redox reaction is indicated by current flowing through the cell. The voltage scan is then reversed and the redox reaction is reversed. If the areas of the two redox waves are the same the process was reversible. The potential at which these events occur give the value of the reduction or oxidation potential relative to a reference. The reference can be an external electrode, such as Ag/AgCl or SCE, or it can be an internal one, such as ferrocene, which has a known oxidation potential. The latter is often preferred for organic solvents, since the common reference electrodes are water based. Although this is a solution process, in contrast to the solid state OLED, and the reference may be hard to adjust to give values relative to vacuum, the method is good for giving relative numbers. One useful parameter that may come from electrochemical measurement is the carrier gap. If both the reduction and oxidation are reversible, one can determine the energy difference between the hole and the electron (i.e. taking an electron out of the HOMO versus putting one into the LUMO). This value is important to determine the LUMO energy from a well defined HOMO energy. If either of the redox processes are not reversible, the carrier gap cannot be determined by this method.

The preferred method to estimate HOMO energies in the solid state is UPS. This is a photoelectric measurement, where the solid is irraditated with UV photons. The energy of the photons are gradually increased until photogenerated electrons are observed. The onset of ejected electrons gives the energy of the HOMO. The photons at that energy have just enough energy to eject an electron form the top of the filled levels. Inverse photoemission involves pre-reducing the sample and then probing the filled states to estimate the LUMO energies. The best accepted method for determining HOMO energies is UPS, which gives values in eV relative to vacuum. This is the binding energy for the electron.

Another important parameter is the optical gap. This value is typically determined from the intersection of the normalized absorption and emission spectra. For a molecule that has very little structural rearrangement in the excited state, the gap between the absorption and emission λₘₐₓ values is rather small and this intersection energy is a good estimate of the optical gap (the 0-0 transition energy). This is often held to be the HOMO-LUMO gap. In some cases, this can be a poor estimation if the shift between the absorption and emission maxima is large (Stokes shift), such that the optical gap is hard to determine. If there is a structural rearrangement in the excited state or the absorption that is measured is not the one for the lowest energy excited state, then there can be a large error. Alternatively, the edge of the absorption or emission bands may be used to estimate the optical gap. In some cases, this is a poor estimate. When the optical gap is used to estimate LUMO energies from a measured HOMO energy, it is most useful for a well behaved molecule (i.e. a small Stokes shift), where it is close to the HOMO-LUMO gap. Even in this case, a carrier gap may be a better estimate and may be larger than the optical gap. If one is concerned about exciton blocking, the edge of the absorption band is more useful, as this will give the energy below which excitons will not be efficiently trapped. That is to say, if an exciton of lower energy than the band edge of the materials approaches a layer with a higher energy absorption edge the likelihood that the exciton will be transferred into this material is low. For molecules emitting from triplet excited states, the absorption edge is the best estimate, since the intersystem crossing may lead to a very large Stokes shift.

A wide variety of materials may be used as the wide gap host according to the present invention. In general, wide gap host materials should be capable of forming a stable amorphous film and have a high triplet energy. Preferably, the high gap host material has a melting point above about 90° C. and a glass transition temperature (T_{g}) above about 85° C. Materials for use as wide gap hosts include, but are not limited to high molecular weight alkanes, polyalkanes (e.g. polyethylene, polyisobutylene, etc.), arylsilanes, siloxanes, silsequioxanes, nonconjugated polyarylelnes (e.g. polystyrene, paralene, etc.), carboranes, and the like, and mixtures thereof.

In one embodiment, the devices of the present invention comprise an emissive layer, wherein the emissive layer comprises a host material of the formula I

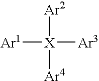

wherein, X is C, Si, Ge, Sn, Pb, Se, Ti, Zr, or Hf;

Ar¹, Ar², Ar³ and Ar⁴ are each an aromatic group independently selected from phenyl, and single-ring heteroaryl;

each of Ar¹, Ar², Ar³ and Ar⁴ may be independently substituted with one or more of alkyl, alkenyl, alkoxy, aryl, aralkyl, halogen, NH₂, NHR, NR₂ and CN;

and additionally or alternatively, one or more of Ar¹, Ar², Ar³ and Ar⁴ may be linked together by a linking group selected from a covalent bond, —O—, —CH₂—, —CHR—, —CR₂—, —NH— and —NR—;

each R is selected from alkyl, alkenyl, aryl, and aralkyl; and

wherein at least one of Ar¹, Ar², Ar³ and Ar⁴ is substituted or linked by a linking group.

In preferred embodiments of the invention, X is Si.

In selecting a compound of the formula I for use as a wide gap host material for use in combination with a particular emissive dopant, the effect of the substituents on the charge carrying properties of the aromatic groups Ar¹, Ar², Ar³ and Ar⁴ may be considered. When the aromatic groups are substituted by strongly electron donating groups, the HOMO of the resulting host material will be higher, thus facilitating hole transport. When the aromatic groups are substituted by strongly electron withdrawing substituents, the LUMO of the resulting material will be lower, thus facilitating electron transport. In the case where the host material does not transport holes or electron, strongly donating and strongly withdrawing groups are preferably avoided. Thus, in a further embodiment of the invention, the wide gape host is a material of the formula I wherein the aromatic groups Ar¹, Ar², Ar³ and Ar⁴ independently may be unsubstituted or may be substituted with one or more of alkyl, alkenyl, aralkyl and halogen. The degree of conjugation may also effect the properties of the host material. It is preferred that the aromatic groups Ar¹, Ar², Ar³ and Ar⁴ not be substituted with conjugating substituents as this has the effect of lowering the HOMO/LUMO band gap and, thus, also the triplet energy. The linking group is subject to the same considerations. Thus, the linking group is preferably selected from —O—, —CH₂—, —CHR—, and —NR—. More preferably, the linking group is selected from —CH₂—, —CHR— and CR₂.

In a preferred embodiment of the invention, the emissive layer comprises a host material of the formula I, wherein Ar¹, Ar², Ar³ and Ar⁴ are each phenyl, and Ar¹ and Ar², and Ar³ and Ar⁴ are linked together by linking groups to give a compound of the formula II

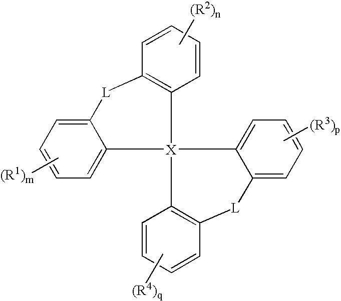

wherein X is C, Si, Ge, Sn, Pb, Se, Ti, Zr, or Hf;

each R¹ is independently selected from alkyl, alkenyl, alkoxy, aryl, aralkyl, halogen, NH₂, NHR, NR₂ and CN;

each R² is independently selected from alkyl, alkenyl, alkoxy, aryl, aralkyl, halogen, NH₂, NHR, NR₂ and CN;

each R³ is independently selected from alkyl, alkenyl, alkoxy, aryl, aralkyl, halogen, NH₂, NHR, NR₂ and CN;

each R⁴ is independently selected from alkyl, alkenyl, alkoxy, aryl, aralkyl, halogen, NH₂, NHR, NR₂ and CN;

each L is independently selected from a covalent bond, —O—, —CH₂—, —CHR—, CR₂ and —NR—;

each R is selected from alkyl, alkenyl, aryl, and aralkyl;

each of n, m, p and q are independently selected from the values 0, 1, 2, 3 and 4.

For the compounds disclosed herein, each occurrence of a substituent (for example, R¹, R², R³, and R⁴) is independently selected form the group provided. For example, in the case where n is 2, 3 or 4, each substituent R¹ attached to the phenyl ring would be selected independently from the group provided.

In a further embodiment of the invention, the emissive layer comprises a host material of the formula II wherein the both linking groups (L) are —CH₂— to give a compound of the formula III

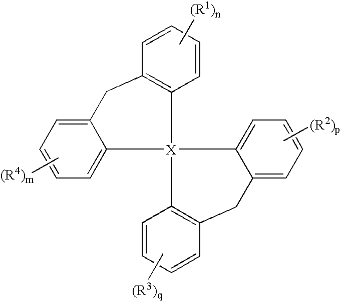

wherein X, R¹, R², R³, R⁴, n, m, p and q are as defined above for the compound of the formula II.

In another embodiment of the invention, the emissive layer comprises a host material of the formula I, wherein Ar¹, Ar², Ar³ and Ar⁴ are each phenyl to give a compound of the formula IV

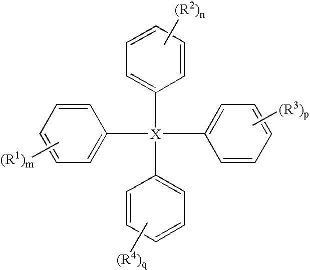

wherein X is C, Si, Ge, Sn, Pb, Se, Ti, Zr, or Hf;

each R¹ is independently selected from alkyl, alkenyl, alkoxy, aryl, aralkyl, halogen, NH₂, NHR, NR₂ and CN;

each R² is independently selected from alkyl, alkenyl, alkoxy, aryl, aralkyl, halogen, NH₂, NHR, NR₂ and CN;

each R³ is independently selected from alkyl, alkenyl, alkoxy, aryl, aralkyl, halogen, NH₂, NHR, NR₂ and CN;

each R⁴ is independently selected from alkyl, alkenyl, alkoxy, aryl, aralkyl, halogen, NH₂, NHR, NR₂ and CN;

each of n, m, and p are independently selected from the values 0, 1, 2, 3 and 4; and

q is selected from the values 1, 2, 3 and 4.

For the compounds of the formula IV, it is important that at least one of the phenyl rings be substituted as this generally results in materials that form amorphous films, in contrast to the unsubstituted compounds. More preferably, at least two of the phenyl rings will have one or more substituents.

The wide gap host material used in the present invention may be selected from polyhedral oligomeric silsesquioxanes. Preferred materials of this class include compounds of the formula V

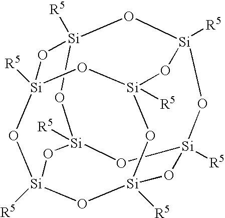

wherein R⁵ is selected from alkyl, cycloalkyl, phenyl, heteroaryl and aralkyl, each or which may be optionally substituted with one or more halogen, alkyl, alkenyl, alkoxy, aryl, aralkyl, NH₂, NHR, NR₂ and CN. In a preferred embodiment, R⁶ is a substituted or unsubstituted phenyl.

The term “halo” or “halogen” as used herein includes fluorine, chlorine, bromine and iodine.

The term “alkyl” as used herein contemplates both straight and branched chain alkyl radicals. Preferred alkyl groups are those containing from one to fifteen carbon atoms and includes methyl, ethyl, propyl, isopropyl, butyl, isobutyl, tert-butyl, and the like. Additionally, the alkyl group may be optionally substituted with one or more substituents selected from halo, CN, CO₂R, C(O)R, NR₂, cyclic-amino, NO₂, and OR.

The term “cycloalkyl” as used herein contemplates cyclic alkyl radicals. Preferred cycloalkyl groups are those containing 3 to 7 carbon atoms and includes cyclopropyl, cyclopentyl, cyclohexyl, and the like. Additionally, the cycloalkyl group may be optionally substituted with one or more substituents selected from halo, CN, CO₂R, C(O)R, NR₂, cyclic-amino, NO₂, and OR.

The term “alkenyl” as used herein contemplates both straight and branched chain alkene radicals. Preferred alkenyl groups are those containing two to fifteen carbon atoms. Additionally, the alkenyl group may be optionally substituted with one or more substituents selected from halo, CN, CO₂R, C(O)R, NR₂, cyclic-amino, NO₂, and OR.

The term “alkynyl” as used herein contemplates both straight and branched chain alkyne radicals. Preferred alkyl groups are those containing two to fifteen carbon atoms. Additionally, the alkynyl group may be optionally substituted with one or more substituents selected from halo, CN, CO₂R, C(O)R, NR₂, cyclic-amino, NO₂, and OR.

The term “aralkyl” as used herein contemplates an alkyl group which has as a substituent an aromatic group. Additionally, the aralkyl group may be optionally substituted on the aryl with one or more substituents selected from halo, CN, CO₂R, C(O)R, NR₂, cyclic-amino, NO₂, and OR.

The term “heteroaryl group” as used herein contemplates cyclic aromatic radicals that contain at least one heteroatom (for example, N, O, S, etc.) as one of the ring atoms. Heteroaryl groups will can contain 5 or 6 ring atoms, which includes at least one hetero atom, for example, pyrrole, furan, thiophene, imidazole, oxazole, thiazole, triazole, pyrazole, pyridine, pyrazine and pyrimidine, and the like. Preferred heteroaryl groups are pyridine and pyrimidine. Additionally, the heteroaryl group may be optionally substituted with one or more alkyl, alkenyl, alkoxy, aryl, aralkyl, halogen, and CN.

The term “aryl” or “aromatic group” as used herein contemplates single-ring aromatic groups, including substituted or unsubstituted phenyl and aromatic heterocyclic groups such as substituted or unsubstituted pyridine, pyrimidine and the like. Additionally, the aromatic group may be optionally substituted with one or more alkyl, alkenyl, alkoxy, aryl, aralkyl, halogen, and CN. When one or more of the aromatic groups Ar¹, Ar², Ar³ and Ar⁴ are substituted with an aryl group, it is preferred that the aromatic group and/or the aryl substituent be further substituted (i.e., having alkyl groups in the ortho position relative to the bond linking two aromatic groups) so that the two adjacent rings cannot be co-planar.

It is understood that the various embodiments described herein are by way of example only, and are not intended to limit the scope of the invention. For example, many of the materials and structures described herein may be substituted with other materials and structures without deviating from the spirit of the invention. It is understood that various theories as to why the invention works are not intended to be limiting. For example, theories relating to charge transfer are not intended to be limiting.

Material Definitions:

As used herein, abbreviations refer to materials as follows:

CBP: 4,4′-N,N-dicarbazole-biphenyl

m-MTDATA 4,4′,4″-tris(3-methylphenylphenlyamino)triphenylamine

Alq₃: 8-tris-hydroxyquinoline aluminum

Bphen: 4,7-diphenyl-1, 10-phenanthroline

n-BPhen: n-doped BPhen (doped with lithium)

F₄-TCNQ: tetrafluoro-tetracyano-quinodimethane

p-MTDATA: p-doped m-MTDATA (doped with F₄-TCNQ)

Ir(ppy)₃: tris(2-phenylpyridine)-iridium

Ir(ppz)₃: tris(1-phenylpyrazoloto,N,C(2′)iridium(III)

BCP: 2,9-dimethyl-4,7-diphenyl-1,10-phenanthroline

TAZ: 3-phenyl-4-(1′-naphthyl)-5-phenyl-1,2,4-triazole

CuPc: copper phthalocyanine.

ITO: indium tin oxide

NPD: naphthyl-phenyl-diamine

TPD: N,N′-bis(3-methylphenyl)-N,N′-bis-(phenyl)-benzidine

BAlq: aluminum(III)bis(2-methyl-8-quinolinato)4-phenylphenolate

mCP: 1,3-N,N-dicarbazole-benzene

DCM: 4-(dicyanoethylene)-6-(4-dimethylaminostyryl-2-methyl)-4H-pyran

DMQA: N,N′-dimethylquinacridone

PEDOT:PSS: an aqueous dispersion of poly(3,4-ethylenedioxythiophene) with polystyrenesulfonate (PSS)

Ir(4,6-F₂ ppy)₂(BPz₄) iridium(III) bis(2-(4,6-difluorphenyl)pyridinato-N, C²)η²-N,N′-(tetrakis(1-pyrazolyl)borate)

Experimental:

Specific representative embodiments of the invention will now be described, including how such embodiments may be made. It is understood that the specific methods, materials, conditions, process parameters, apparatus and the like do not necessarily limit the scope of the invention.

Where available, solvents and reagents were purchased from Aldrich Chemical Company. The reagents were of the highest purity and used as received. Octaphenyl-polyhedral oligomeric silsesquioxane was purchased from Hybrid Plastics.

Synthesis of 5,5′-spirobi(dibenzosilole)

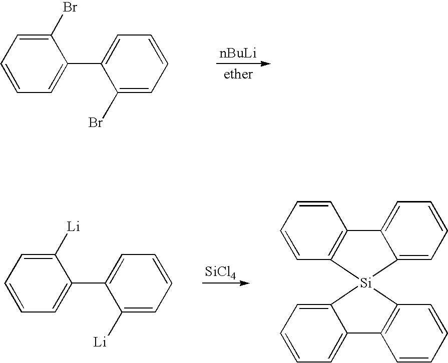

5,5′-Spirobi(dibenzosilole) was prepared according to the proceedure provided in “Cyclic organosilicon compounds. I. Synthesis of compounds containing the dibenzosilole nucleus.” Gilman, Henry; Gorisch, Richard D. J. Am. Chem. Soc. 1958, 80 1883-6.

Synthesis of diphenyldi(o-tolyl)silane

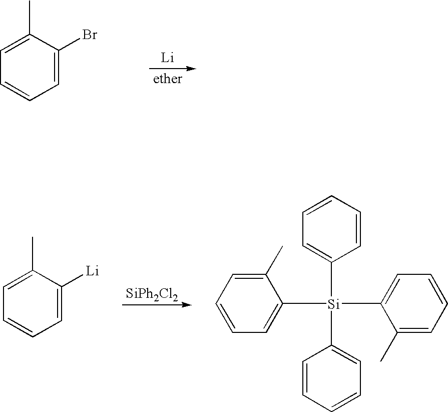

Diphenyldi(o-tolyl)silane was prepared according to the procedure of “Tetraaryl-methane analogs in group 14. V. Distortion of tetrahedral geometry in terms of through-space p-p and p-s interactions and NMR sagging in terms of p-s charge transfer.” Charisse, Michael; Zickgraf, Andrea; Stenger, Heike; Brau, Elmar; Desmarquet, Cristelle; Drager, Martin; Gerstmann, Silke; Daktemieks, Dainis; Hook, James. Polyhedron 1998, 17(25-26), 4497-4506.

Synthesis of 9,9-spirobissilaanthracene.

9,9-Spirobissilaanthracene was prepared according to the procedure of “9-Sila-, -germa-, and -stannadihydroanthracenes.” Jutzi, Peter. Chemische Berichte 1971, 104(5), 1455-67.

mCP was prepared by the palladium-catalyzed cross coupling of aryl halides and arylamines. (T. Yamamoto, M. Nishiyama, Y. Koie Tet. Lett., 1998, 39, 2367-2370).

Device Fabrication

Prior to device fabrication, indium tin oxide (ITO) on glass was patterned as 2 mm wide stripes (sheet resistance 20 Ω/□) The substrates were cleaned by sonication in soap solution, rinsing with deionized water, boiled in trichloroethylene, acetone and ethanol for 3-4 min in each solvent. After the cleaning procedure, the substrates were dried under an N₂ flow followed by UV ozone treatment for 10 min.

Organic layers of the OLEDs were sequentially deposited by thermal evaporation from resistively heated tantalum boats onto the substrates, at room temperature, at a base pressure of 3-4×10⁻⁶ Torr, at 2.5 Å/s. The rate of a single-component layer was controlled with one Inficon thickness monitor located close to the substrate. For the two-component emissive layer the rate of the dopant was controlled with an additional crystal monitor located close to the dopant evaporation source. The additional monitor was not exposed to the major flow of the host, which allowed increasing the precision of the dopant concentration.

The devices were characterized in the air within 2 h of fabrication. Current-voltage measurements were made with a Keithley source meter (model 2400). Light intensity was measured using a Newport model 1835 optical power meter and 818-UV Newport detector. EL spectra were measured with a Photon Technology International fluorimeter.

### EXAMPLE 1

An OLED with the structure ITO/NPD(400 Å)/Irppy:Si(bph)₂(8%, 300 Å)/BCP(150 Å)/Alq(250 Å)/LiF/Al was fabricated. For comparison, a second device was fabricated with the same device structure except using CBP as the host material for the emissive layer.

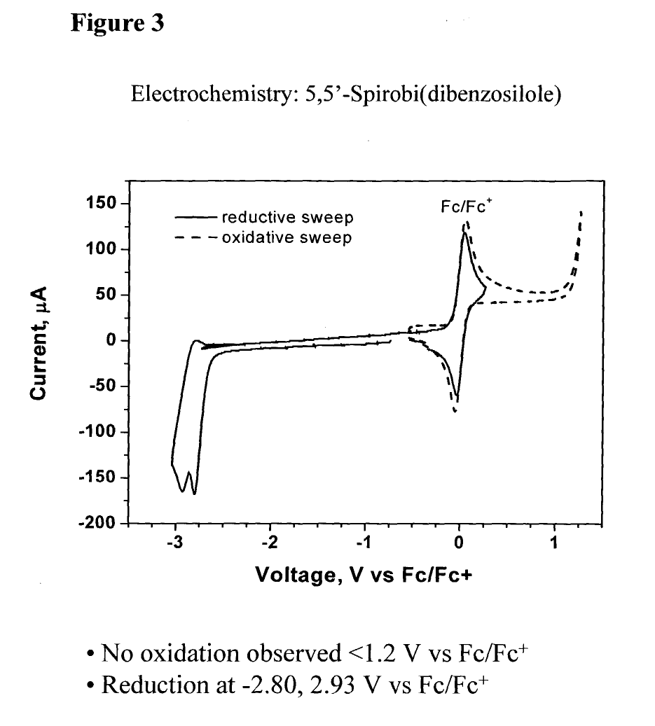

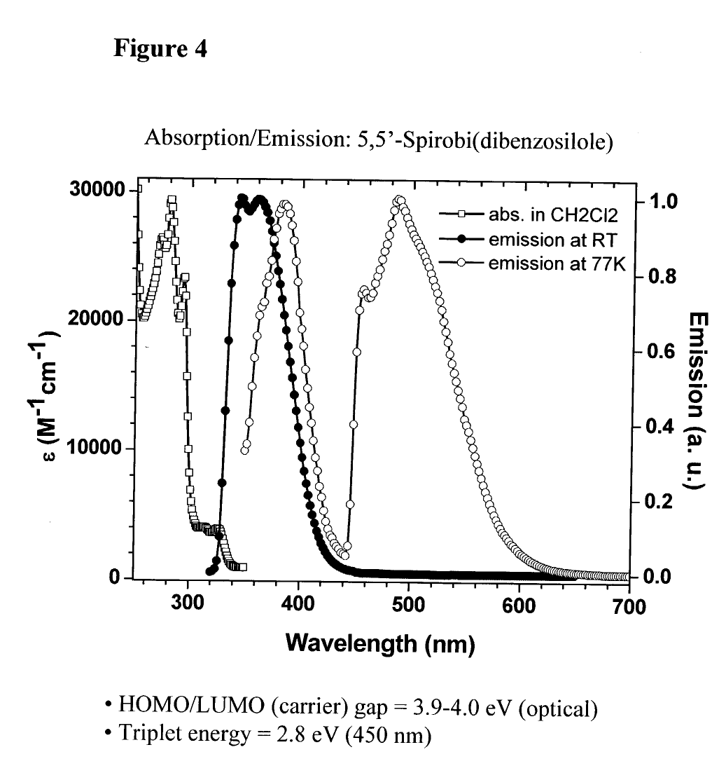

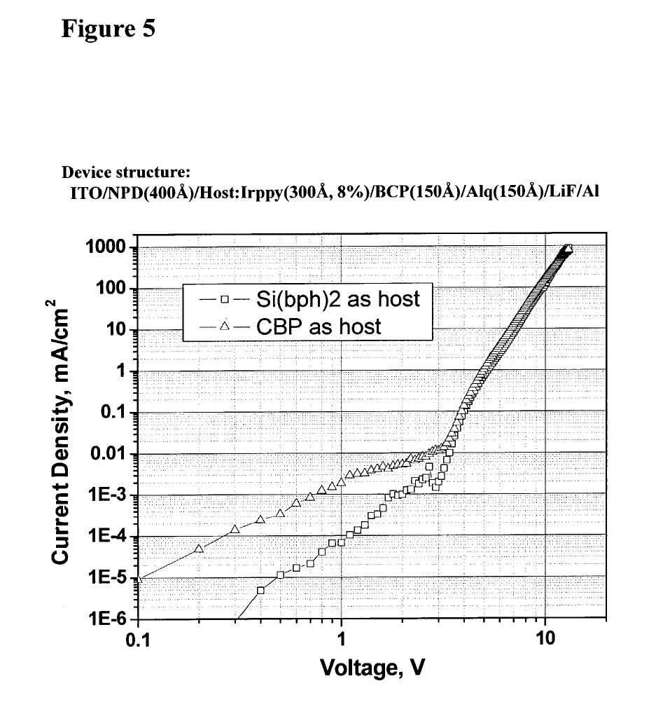

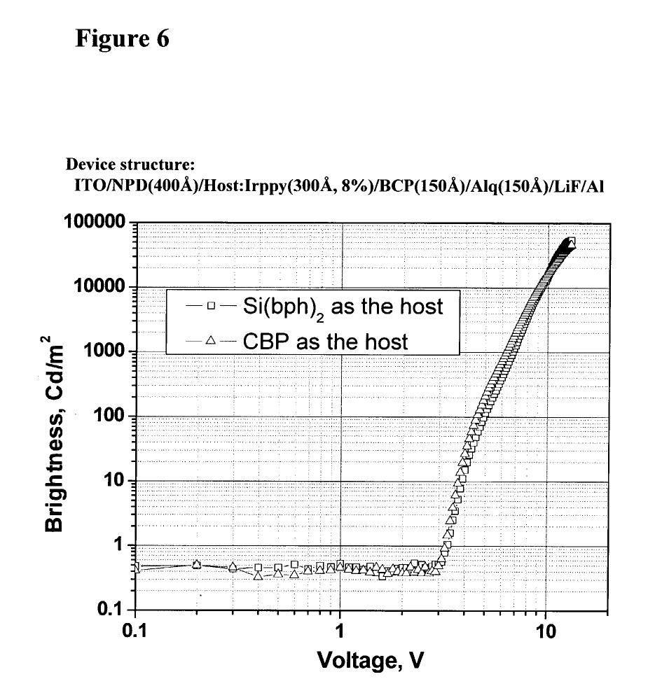

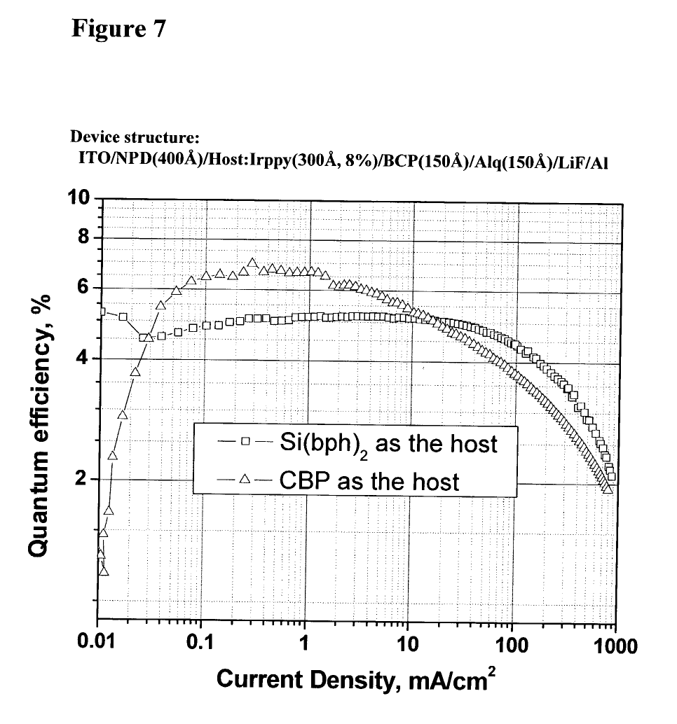

The electrochemical data for Si(bph)₂ is given in FIG. 3. The triplet energy of the biphenyl moiety is very low, and leads to a fairly low triplet energy for this material (see FIG. 4). Thus, Si(bph)₂ will not be a good host material for blue OLEDs, since its triplet energy is in the green region. The data shows that this host is a useful material for green devices, but doesn't perform as well as CBP, overall. The current vs. voltage and brightness vs voltage lots are similar for both hosts (FIGS. 5 and 6). The device with the Si(bph)₂ host has flatter quantum efficiency curve, with a quantum efficiency of 4.5% @ 10,000 Cd/m² (FIG. 7).

### EXAMPLE 2

An OLED with the device structure ITO/NPD(400 Å)/Irppy:Siph₂(o-tolyl)₂(8%, 300 Å)/BCP(150 Å)/Alq(250 Å)/LiF/Al was fabricated. For comparison a second device was fabricated in which the host was CBP.

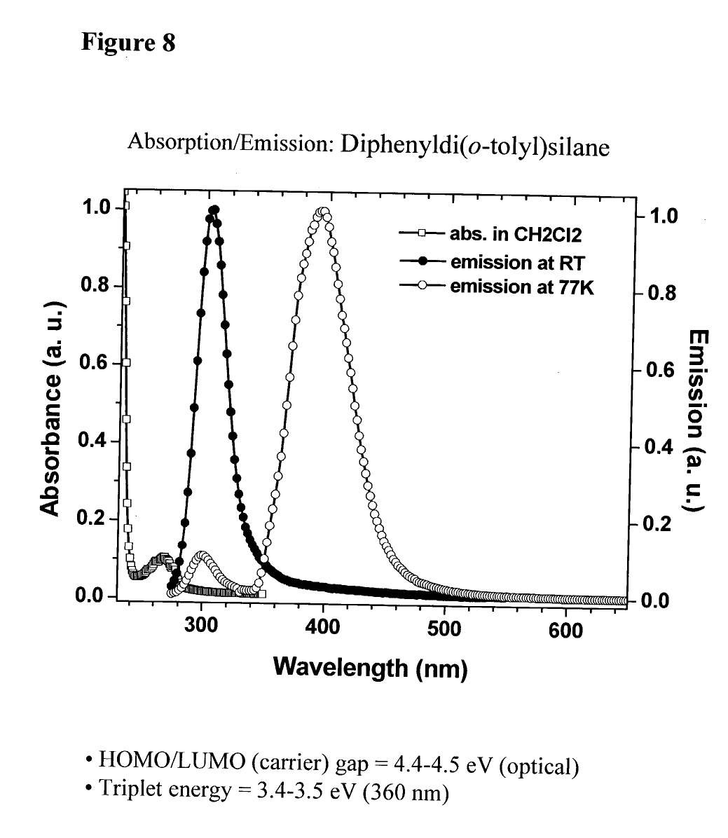

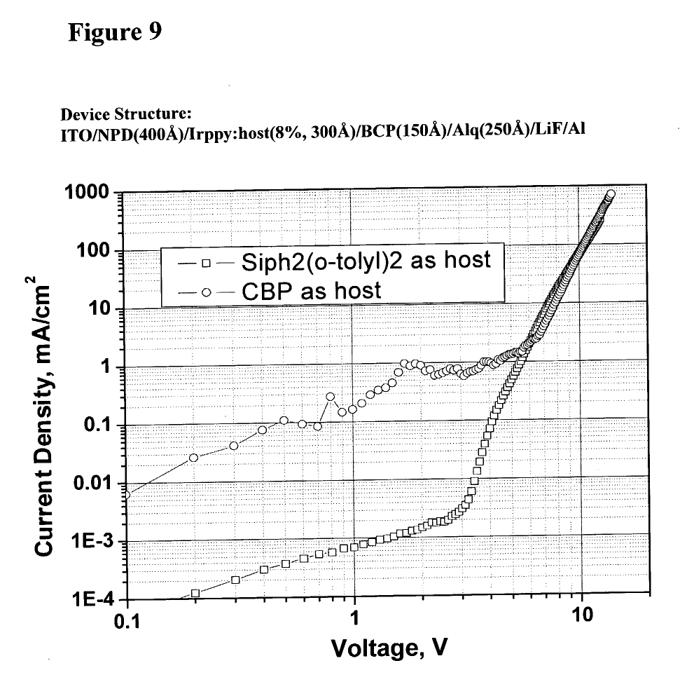

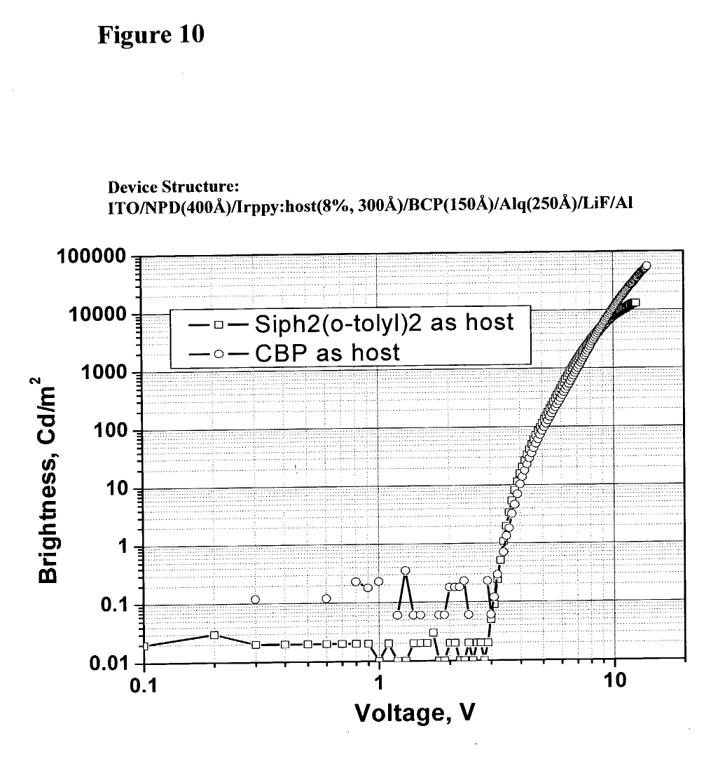

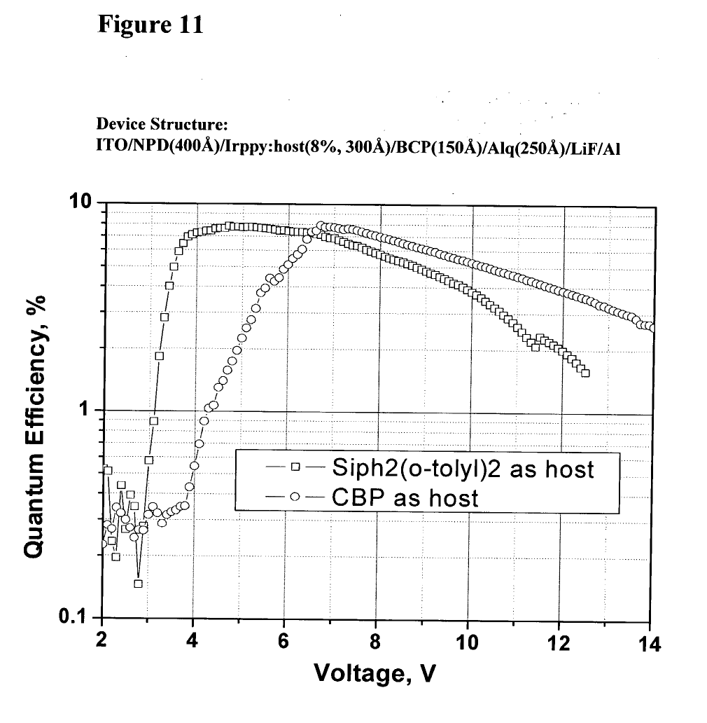

Siph₂(o-tolyl)₂ was determined to have a HOMO/LUMO (carrier) gap of 4.4-4.5 eV (optical) and a triplet energy of 3.4-3.5 eV (360 nm) (FIG. 8). This compound has a high energy gap and so may be suitable as a wide gap host. The current density vs. voltage, brightness vs. voltage, and quantum efficiency vs. voltage plots (FIGS. 9, 10 and 11) indicate that for a green dopant (Irppy) is comparable as a host material to CBP. The data shows that Siph₂(o-tolyl)₂ can be used as an efficient host material.

### EXAMPLE 3

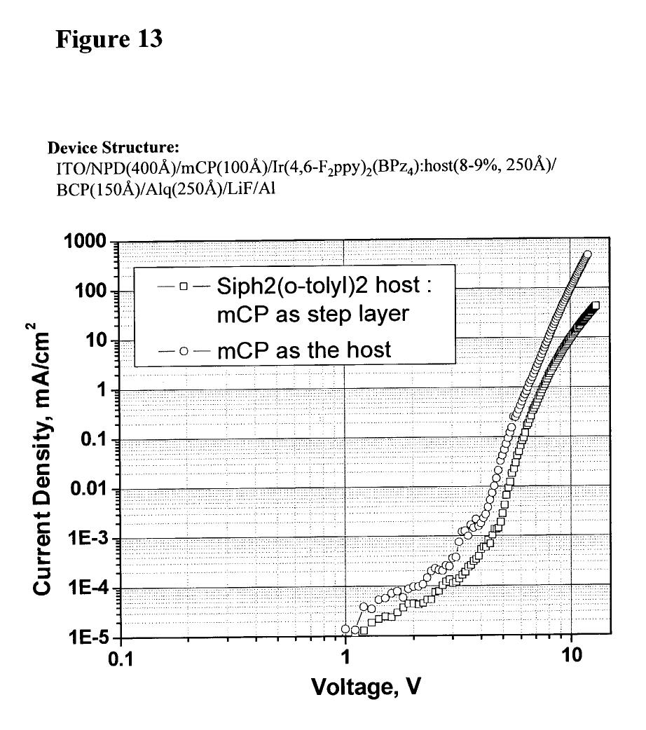

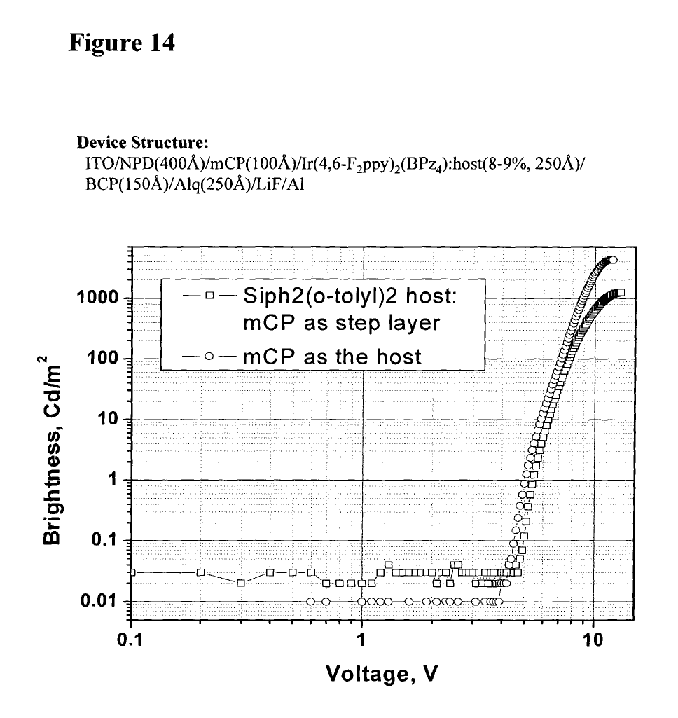

An OLED with the device structure ITO/NPD(400 Å)/mCP(100 Å)/Ir(4,6F₂ppy)₂(BPz₄):Siph₂(O-tolyl)₂(8-9%, 250 Å)/BCP(150 Å)/Alq(250 Å)/LiF/Al was fabricated. This device is characterized in FIGS. 13-15. For comparison a second device was fabricated in which the host was CBP.

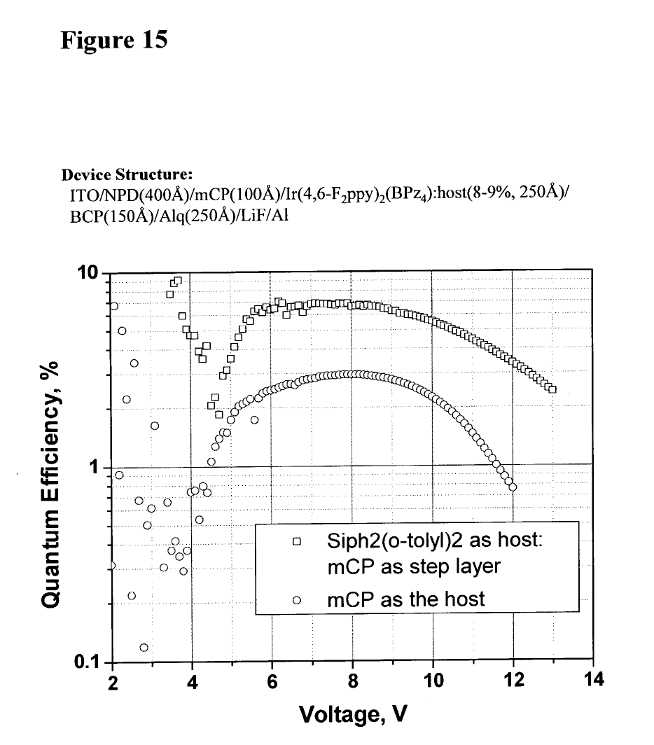

The energy gap of siph₂(o-tolyl)₂ is estimated to be 4.45 eV, and its HOMO lies beneath that of Ir(4,6-F₂ ppy)₂(BPz₄). For this device, which uses a blue emitting dopant (Ir(4,6F₂ppy)₁(BPz₄)), siph₂(o-tolyl)₂ is a superior host material than mCP. The siph₂(o-tolyl)₂/Ir(4,6F₂ppy)₂(BPz₄) device shows a quantum efficiency of about 7% at 8 V, which is higher than quantum efficiency observed for the mCP based device (FIG. 15). This is consistent with a higher triplet energy on the siph₂(o-tolyl)₂ host, giving less energy transfer quenching. A layer of mCP between HTL and EML acts as an energy step layer to facilitate hole injection into the dopant. The mCP layer may also act to block electron leakage.

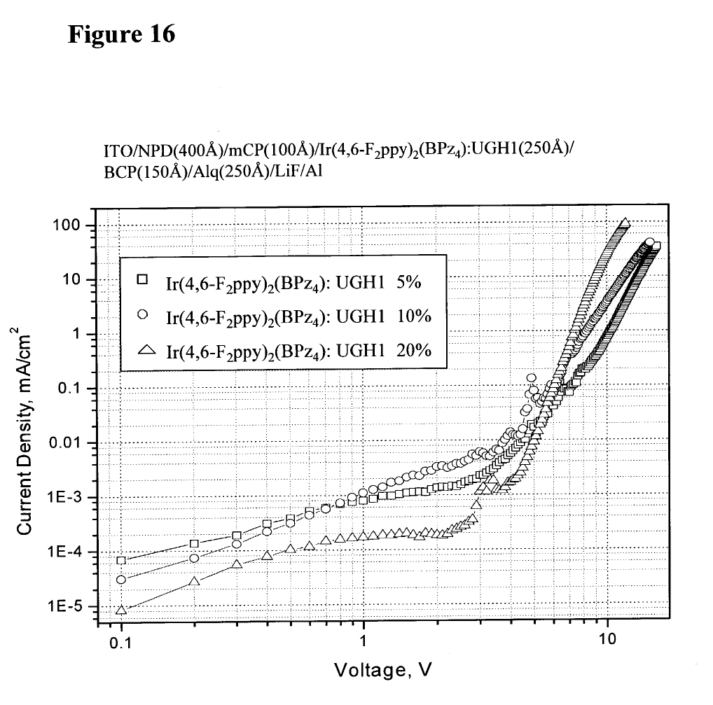

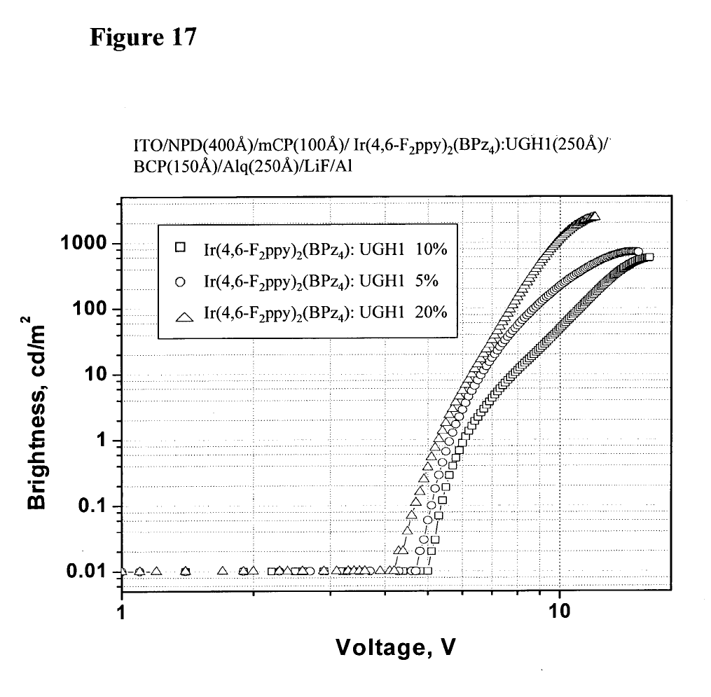

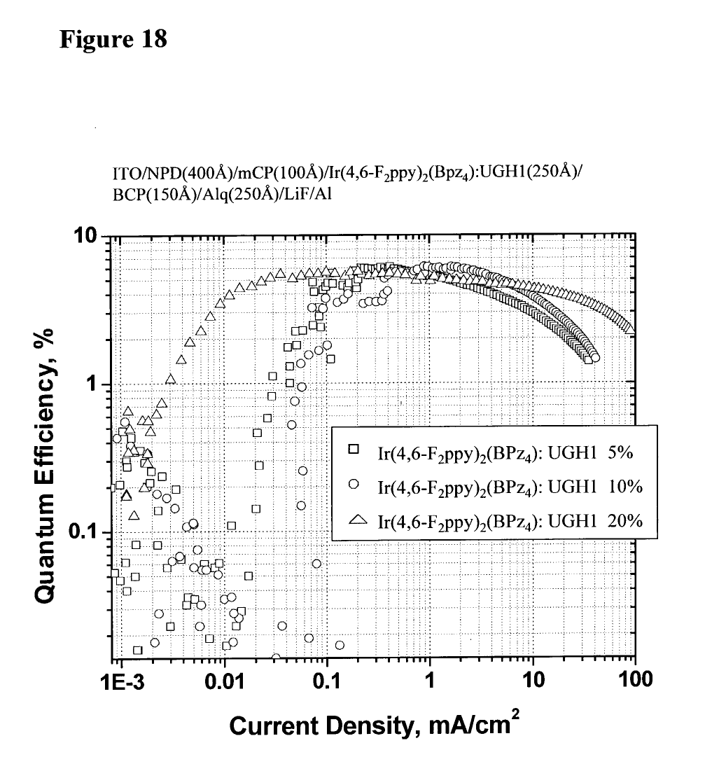

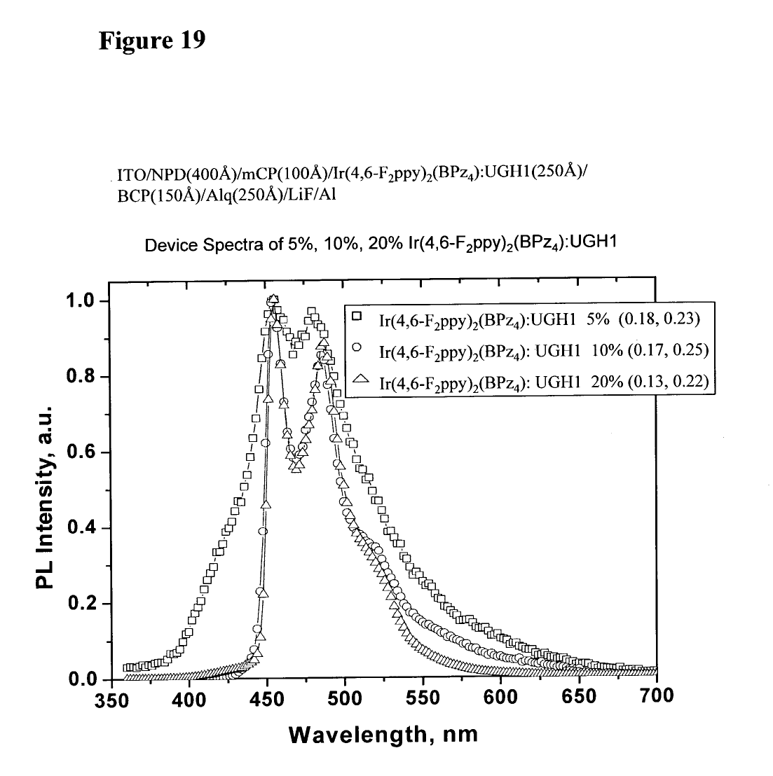

The device ITO/NPD(400 Å)/mCP(100 Å)/Ir(4,6-F₂ ppy)₂(BPZ4):UGH1 (250 Å)/BCP(150 Å)/Alq(250 Å)/LiF/Al was prepare with various dopant concentrations (5%, 10% and 20% Ir(4,6-F₂ ppy)₂(BPz₄)). The current density vs. voltage plot, the brightness vs. voltage plot, the quantum efficiency vs. current density plot, and photoluminescence spectra are given by FIG. 16, FIG. 17, FIG. 18 and FIG. 19, respectively.

### EXAMPLE 4

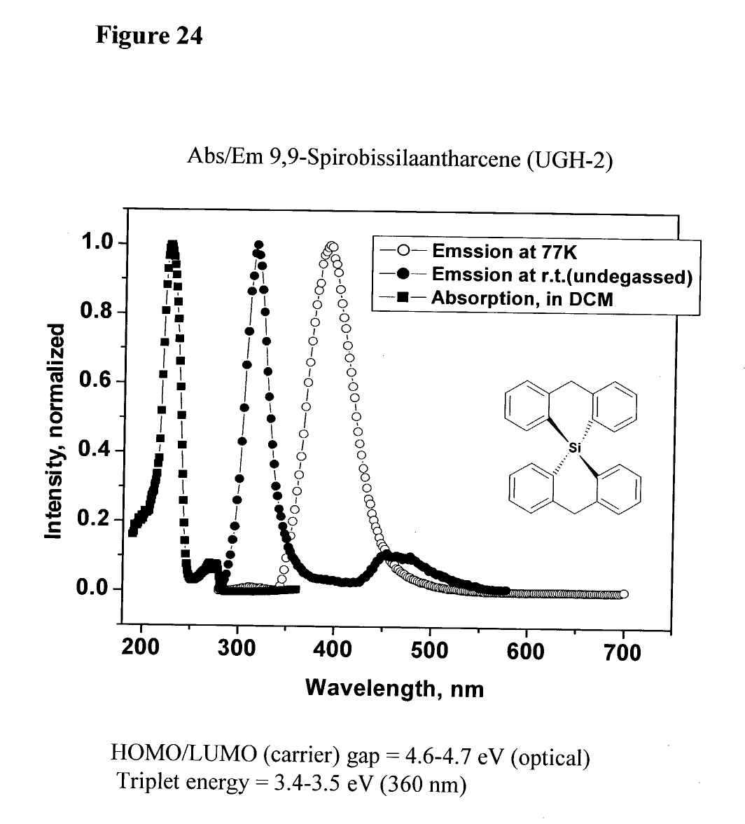

9,9-Spirobissilaantharcene was evaluated for use as a wide gap host material. Using the absorption and emission spectra the HOMO/LUMO (carrier) gap was determined to be 4.6-4.7 eV (optical) and the triplet energy was determined to be 3.4-3.5 eV (360 nm) (FIG. 24).

### EXAMPLE 5

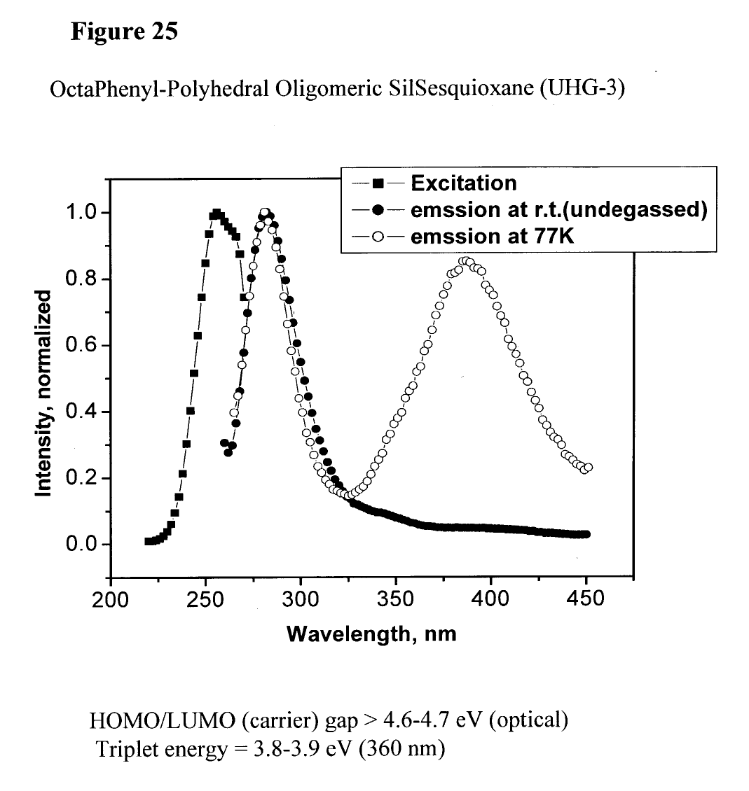

Octaphenyl-polyhedral oligomeric silsesquioxane was evaluated for use as a wide gap host material. Using the absorption and emission spectra the HOMO/LUMO (carrier) gap was determined to be 4.6-4.7 eV (optical) and the triplet energy was determined to be 3.8-3.9 eV (360 nm) (FIG. 25).

### EXAMPLE 6

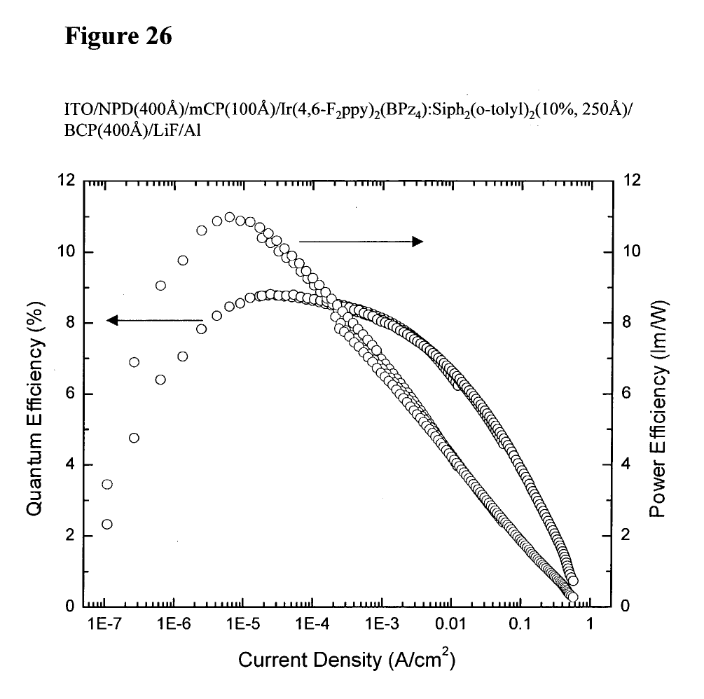

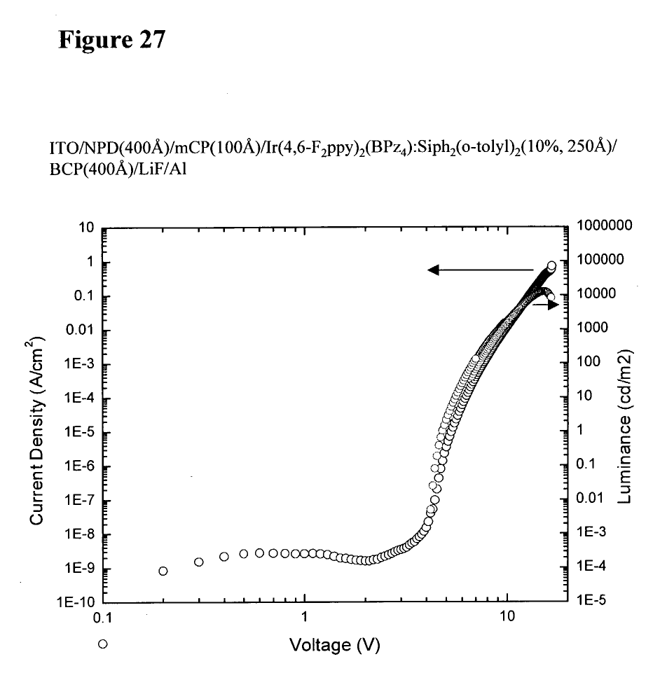

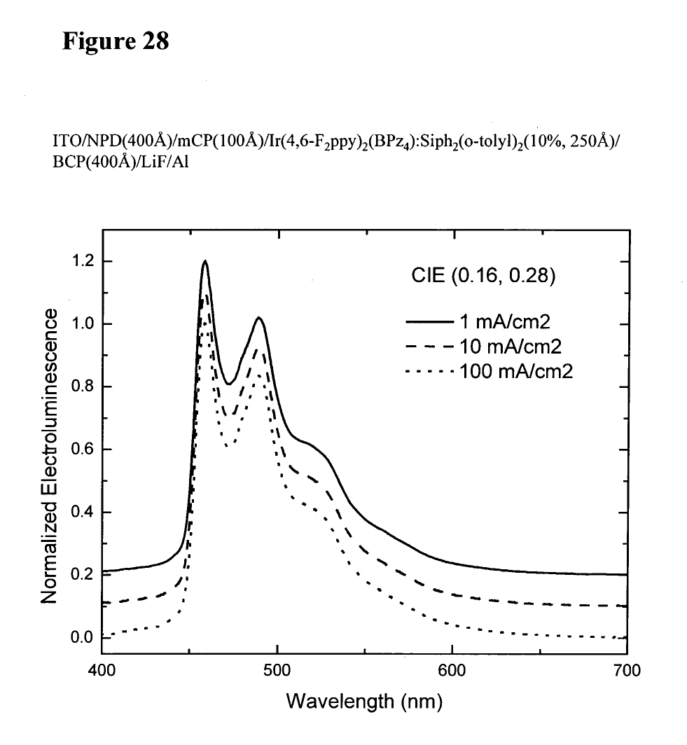

An OLED with the device structure ITO/NPD(400 Å)/mCP(100 Å)/Ir(4,6-F₂ ppy)₂(BPz₄):Siph₂(o-tolyl)₂(10%, 250 Å)/BCP(400 Å)/LiF/Al was fabricated. The quantum efficiency vs. voltage, current density vs. voltage, luminescence vs. voltage, and electroluminescence spectra are provided (FIGS. 26, 27 and 28). This device shows a high external quantum efficiency of 8.8% for a “simplified” device structure. The device is termed a simplified structure as it require fewer layers to be included in the OLED. In this case, the device does not have both an electron transport layer (ETL) and a blocking layer between the emissive layer and the cathode.

### EXAMPLE 7

OLEDs were constructed with the device structures ITO/NPD(400 Å)/Firpic:UGH1(300 Å)/BCP(150 Å)/Alq(250 Å)/LiF/Al, ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

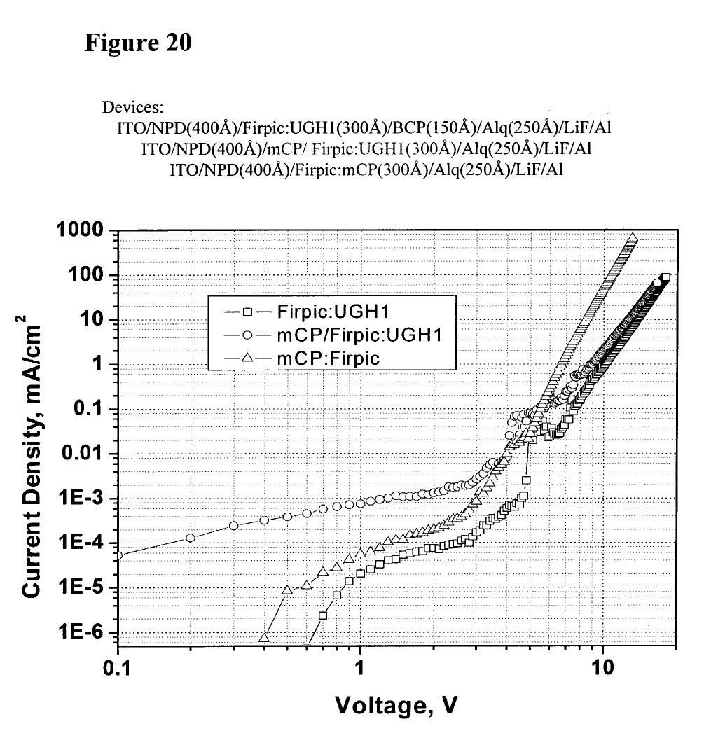

FIG. 20 shows the plots of the current density vs. voltage for the devices ITO/NPD(400 Å)/Firpic:UGH1(300 Å)/BCP(150 Å)/Alq(250 Å)/LiF/Al, ITO/NPD(400 Å)/mCP/Firpic:UGH1 (300 Å)/Alq(250 Å)/LiF/Al, and ITO/NPD(400 Å)/Firpic:mCP(300 Å)/Alq(250 Å)/LiF/Al.

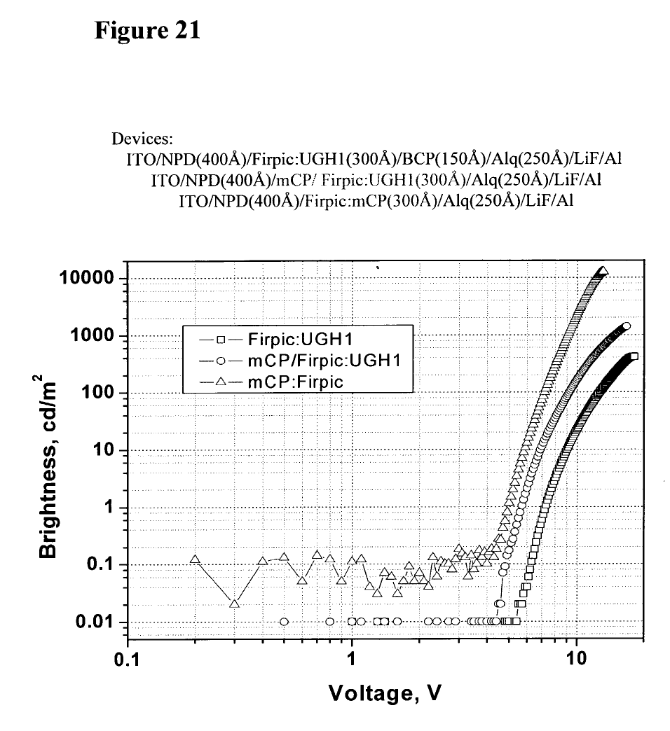

FIG. 21 shows the plots of the brightness vs. voltage for the devices ITO/NPD(400 Å)/Firpic:UGH1(300 Å)/BCP(150 Å)/Alq(250 Å)/LiF/Al, ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

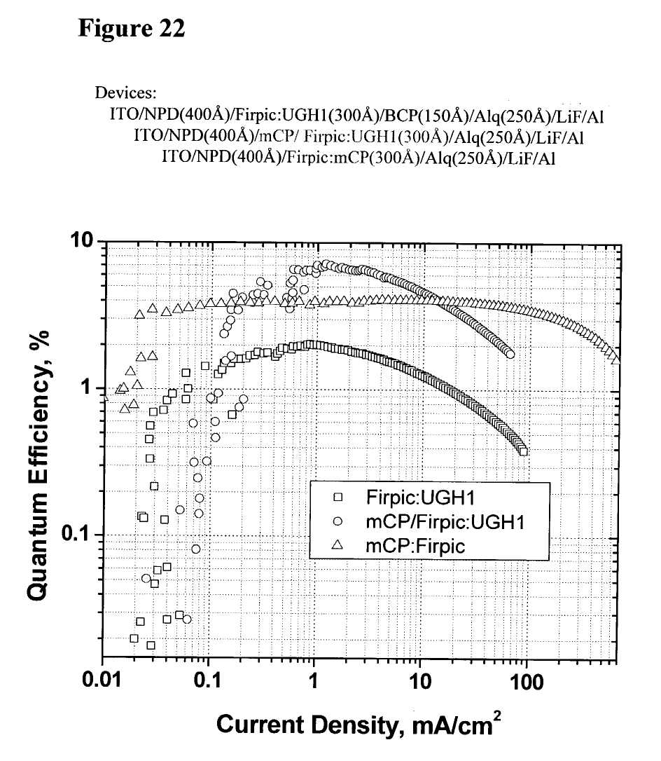

FIG. 22 shows the plots of the quantum efficiency vs. current density for the devices ITO/NPD(400 Å)/Firpic:UGH1 (300 Å)/BCP(150 Å)/Alq(250 Å)/LiF/Al, ITO/NPD(400 Å)/mCP/Firpic:UGH1 (300 Å)/Alq(250 Å)/LiF/Al, and ITO/NPD(400 Å)/Firpic:mCP(300 Å)/Alq(250 Å)/LiF/Al.

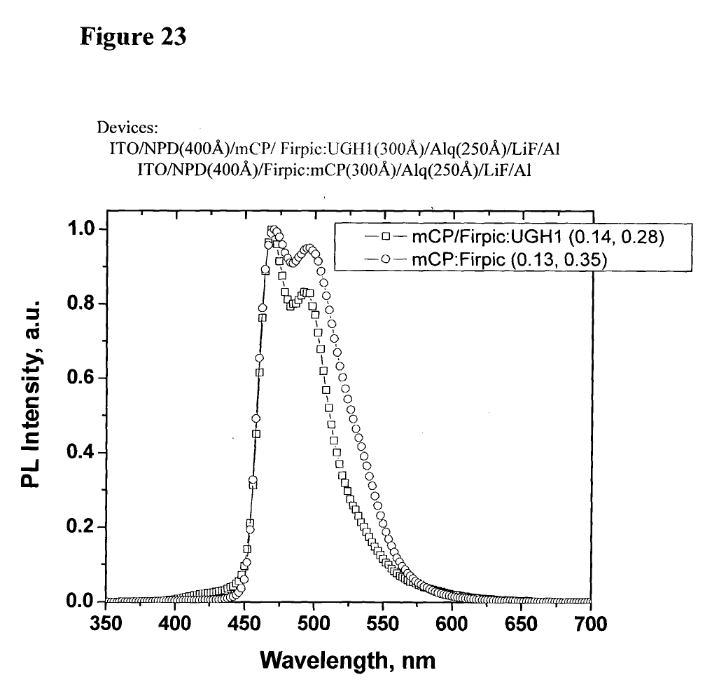

FIG. 23 shows the plots of the photoluminescent spectra for the devices ITO/NPD(400 Å)/mCP/Firpic:UGH1(300 Å)/Alq(250 Å)/LiF/Al, and ITO/NPD(400 Å)/Firpic:mCP(300 Å)/Alq(250 Å)/LiF/Al.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

What is claimed is:

1. An organic light emitting device comprising an emissive layer disposed between and electrically connected to an anode and a cathode, wherein the emissive layer comprises a host material and a phosphorescent emissive material, and wherein
the emissive material is the primary carrier of holes and electrons;
the host material has and energy gap of at least 3.2 eV; and
the device has a external quantum efficiency of at least about 3%.

2. The organic light emitting device of claim 1, wherein the emissive material emits light in the blue region of the visible spectrum.

3. The organic light emitting device of claim 1, wherein the external quantum efficiency is at least about 5%.

4. The organic light emitting device of claim 1, wherein the host has an energy gap of at least 3.5 eV.

5. The organic light emitting device of claim 1, wherein the host is selected from high molecular weight alkanes, polyalkanes, arylsilanes, siloxanes, silsequioxanes, nonconjugated polyarylelnes and carboranes, wherein the host material has a melting point above about 90° C. and a glass transition temperature above about 85° C.

6. An organic light emitting device comprising an emissive layer disposed between and electrically connected to an anode and a cathode, wherein the emissive layer comprises a host material and a phosphorescent emissive material, and wherein
the emissive material is the primary carrier of holes;
the host material is the primary carrier of electrons, and the host material has an energy gap of at least 3.2 eV; and
the device has a external quantum efficiency of at least about 3%.

7. The organic light emitting device of claim 6, wherein the emissive material emits light in the blue region of the visible spectrum.

8. The organic light emitting device of claim 6, wherein the external quantum efficiency is at least about 5%.

9. The organic light emitting device of claim 6, wherein the host has an energy gap of at least 3.5 eV.

10. An organic light emitting device comprising an emissive layer disposed between and electrically connected to an anode and a cathode, wherein the emissive layer comprises a host material and a phosphorescent emissive material, and wherein
the emissive material is the primary carrier of electrons;
the host material is the primary carrier of holes, and the host material has an energy gap of at least 3.2 eV; and
the device has a external quantum efficiency of at least about 3%.

11. The organic light emitting device of claim 10, wherein the emissive material emits light in the blue region of the visible spectrum.

12. The organic light emitting device of claim 10, wherein the external quantum efficiency is at least about 5%

13. The organic light emitting device of claim 10, wherein the host has an energy gap of at least 3.5 eV.

14. An organic light emitting device comprising an emissive layer disposed between and electrically connected to an anode and a cathode, wherein the emissive layer comprises a host material and a phosphorescent emissive material, wherein the host material comprises a compound of the formula I 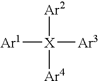
wherein, X is C, Si, Ge, Sn, Pb, Se, Ti, Zr, or Hf;
Ar¹, Ar², Ar³ and Ar⁴ are each an aromatic group independently selected from phenyl, and single-ring heteroaryl;
each of Ar¹, Ar², Ar³ and Ar⁴ may be independently substituted with one or more of alkyl, alkenyl, alkoxy, aryl, aralkyl, halogen, NH₂, NHR, NR₂ and CN;
and additionally or alternatively, one or more of Ar¹, Ar², Ar³ and Ar⁴ may be linked together by a linking group selected from a covalent bond, —O—, —CH₂—, —CHR—, —CR₂—, —NH— and —NR—;
each R is selected from alkyl, alkenyl, aryl, and aralkyl;
wherein at least one of Ar¹, Ar², Ar³ and Ar⁴ is substituted or linked by a linking group;
and wherein the host material has an energy gap of at least 3.2 eV; and
the device has a external quantum efficiency of at least about 3%.

15. The organic light emitting device of claim 14, wherein the host material comprises a compound of the formula I wherein X is Si.

16. The organic light emitting device of claim 14, wherein the host material comprises a compound of the formula IV 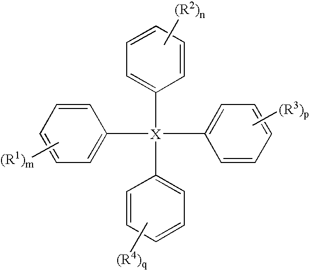
wherein X is C, Si, Ge, Sn, Pb, Se, Ti, Zr, or Hf;
each R¹ is independently selected from alkyl, alkenyl, alkoxy, aryl, aralkyl, halogen, NH₂, NHR, NR₂ and CN;
each R² is independently selected from alkyl, alkenyl, alkoxy, aryl, aralkyl, halogen, NH₂, NHR, NR₂ and CN;
each R³ is independently selected from alkyl, alkenyl, alkoxy, aryl, aralkyl, halogen, NH₂, NHR, NR₂ and CN;
each R⁴ is independently selected from alkyl, alkenyl, alkoxy, aryl, aralkyl, halogen, NH₂, NHR, NR₂ and CN;
each of n, m, and p are independently selected from the values 0, 1, 2, 3 and 4; and
q is selected from the values 1, 2, 3 and 4.

17. The organic light emitting device of claim 16, wherein the host material comprises a compound of the formula IV wherein
each R¹ is independently selected from alkyl, alkenyl, aralkyl and halogen;
each R² is independently selected from alkyl, alkenyl, aralkyl and halogen;
each R³ is independently selected from alkyl, alkenyl, aralkyl and halogen;
each R⁴ is independently selected from alkyl, alkenyl, aralkyl and halogen;
each of n, m, and p are independently selected from the values 0, 1, 2, 3 and 4; and
q is selected from the values 1, 2, 3 and 4.

18. The organic light emitting device of claim 17, wherein the host material comprises a compound of the formula

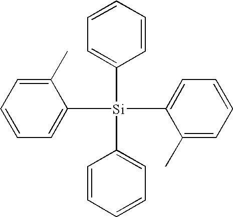

19. The organic light emitting device of claim 14, wherein the emissive material emits light in the blue region of the visible spectrum.

20. An organic light emitting device comprising an emissive layer disposed between and electrically connected to an anode and a cathode, wherein the emissive layer comprises an host material and an emissive material, wherein the host material comprises a compound of the formula II 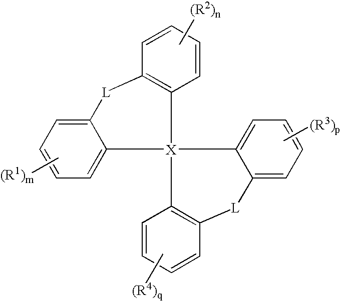
wherein X is C, Si, Ge, Sn, Pb, Se, Ti, Zr, or Hf;
each R¹ is independently selected from alkyl, alkenyl, alkoxy, aryl, aralkyl, halogen, NH₂, NHR, NR₂ and CN;
each R² is independently selected from alkyl, alkenyl, alkoxy, aryl, aralkyl, halogen, NH₂, NHR, NR₂ and CN;
each R³ is independently selected from alkyl, alkenyl, alkoxy, aryl, aralkyl, halogen, NH₂, NHR, NR₂ and CN;
each R⁴ is independently selected from alkyl, alkenyl, alkoxy, aryl, aralkyl, halogen, NH₂, NHR, NR₂ and CN;
each L is independently selected from a covalent bond, —O—, —CH₂—, —CHR—, —CR₂— and —NR—;
each R is selected from alkyl, alkenyl, aryl, and aralkyl; and
each of n, m, p and q are independently selected from the values 0, 1, 2, 3 and 4.

21. The organic light emitting device of claim 20, wherein the host material comprises a compound of the formula II, wherein X is Si.

22. The organic light emitting device of claim 21, wherein the host material comprises a compound of the formula II, wherein L is each L is independently selected from —O—, —CH₂—, —CHR—, —CR₂— and —NR—;

23. The organic light emitting device of claim 22, wherein the host material comprises a compound of the formula II, wherein L is —CH₂—.

24. The organic light emitting device of claim 23, wherein the host material comprises a compound of the formula

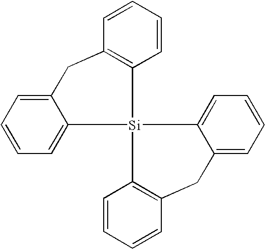

25. The organic light emitting device of claim 20, wherein the emissive material emits light in the blue region of the visible spectrum.

26. An organic light emitting device comprising an emissive layer disposed between and electrically connected to an anode and a cathode, wherein the emissive layer comprises an host material and an emissive material, wherein the host material comprises a compound of the formula V 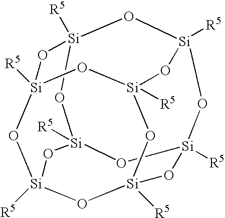
wherein R⁵ is selected from alkyl, cycloalkyl, phenyl, heteroaryl and aralkyl each or which may be unsubstituted or optionally substituted with one or more halogen, alkyl, alkenyl, alkoxy, aryl, aralkyl, NH₂, NHR, NR₂ and CN; and
each R is selected from alkyl, alkenyl, aryl, and aralkyl.

27. The organic light emitting device of claim 26, wherein the host material comprises a compound of the formula V, wherein R⁵ is phenyl, which may be unsubstituted or optionally substituted with one or more halogen, alkyl, alkenyl, alkoxy, aryl, aralkyl, NH₂, NHR, NR₂ and CN.

28. The organic light emitting device of claim 26, wherein the host material comprises a compound of the formula V, wherein R⁵ is phenyl.

29. The organic light emitting device of claim 26, wherein the emissive material emits light in the blue region of the visible spectrum.
